(19) United States
(12) Patent Application Publication
(10) Pub. No.: US 2026/0133516 A1
(43) Pub. Date: May 14, 2026

(54) TONER, TONER SET, IMAGE TRANSFER SHEET, TONER ACCOMMODATING UNIT, IMAGE FORMING APPARATUS, AND IMAGE FORMING METHOD

(71) Applicants: Toyoshi Sawada, Shizuoka (JP); Kazumi Suzuki, Shizuoka (JP); Katsunori Kurose, Shizuoka (JP)

(72) Inventors: Toyoshi Sawada, Shizuoka (JP); Kazumi Suzuki, Shizuoka (JP); Katsunori Kurose, Shizuoka (JP)

(73) Assignee: Etria Co., Ltd., Kanagawa (JP)

(21) Appl. No.: 19/380,304

(22) Filed: Nov. 5, 2025

(30) Foreign Application Priority Data
Nov. 14, 2024 (JP) 2024-199174
May 23, 2025 (JP) 2025-086258

(51) Int. Cl. G03G 9/087; G03G 9/09; G03G 15/01

(52) U.S. Cl. CPC G03G 9/08764; G03G 9/0902; G03G 15/0126; G03G 2215/00527

(57) ABSTRACT

A toner contains a binder resin containing a polyurethane resin, wherein the toner has a true density of 1.30 to 1.80 g/cm³, an average circularity of less than 0.93, a volume average particle diameter of 10 to 30 μm, and an apparent loose bulk density of less than 0.55, wherein the polyurethane resin accounts for at least 51 percent by mass of the toner.

### CROSS-REFERENCE TO RELATED APPLICATIONS

This patent application is based on and claims priority pursuant to 35 U.S.C. § 119 to Japanese Patent Applications Nos. 2024-199174 and 2025-086258 filed on Nov. 14, 2024 and May 23, 2025, in the Japan Patent Office, the entire disclosures of which are hereby incorporated by reference herein.

### BACKGROUND

### Technical Field

The present disclosure relates to a toner, a toner set, an image transfer sheet, a toner accommodating unit, an image forming apparatus, and an image forming method.

### Description of the Related Art

Electrophotography is a method of developing a latent electrostatic image with a developing agent to render the latent electrostatic image visible and forms a latent electrostatic image on a latent electrostatic image bearer containing a photoconductive material, developing the latent electrostatic image with a developing agent containing toner to obtain a toner image, transferring the toner image onto a transfer material, typically paper, and fixing the toner image by applying heat and pressure to obtain a fixed image.

Electrophotography can form a full color image with a typical toner-set of three process color toners of cyan toner, magenta toner, and yellow toner combined with black toner.

Currently, electrophotographic color image forming apparatuses become popular and produce printed matter with various applications. For a sector of consumable goods made to order, electrophotographic printing is highly expected to support a material on which traditional electrophotographic toner for paper media is not printable or fixable. Specifically, the need for printing on fabrics such as uniforms, shoes, and bags for sports teams is increasing.

For toners used to form fixed images on fabric media, properties not required for conventional toners for paper fixing are demanded, such as sufficient fixation onto the uneven surface of textile fibers, and the ability of the fixed toner layer to possess appropriate flexibility so that it can follow the deformation of the fabric. However, a toner that exhibits both excellent fixability to flexible fiber-based media such as fabrics, and superior flexibility, has not yet been found.

### SUMMARY

The present disclosure described herein provides a toner that contains a binder resin containing a polyurethane resin, wherein the toner has a true density of 1.30 to 1.80 g/cm³, an average circularity of less than 0.93, a volume average particle diameter of 10 to 30 μm, and an apparent loose bulk density of less than 0.55, wherein the polyurethane resin accounts for at least 51 percent by mass of the toner.

As another aspect of the present disclosure, a toner set is provided which contains a color toner containing a binder resin and a colorant, and the toner mentioned above.

As another aspect of the present disclosure, an image transfer sheet is provided which contains a support for release and an image formed with the toner mentioned above on the support for release.

As another aspect of the present disclosure, a toner accommodating unit is provided which contains a container and toner mentioned above accommodated in the container.

As another aspect of the present disclosure, an image forming apparatus is provided which contains a latent electrostatic image bearer, a latent electrostatic image forming device to form a latent electrostatic image on the latent electrostatic image bearer, a developing device to develop the latent electrostatic image formed on the latent electrostatic image bearer with a developing agent containing the mentioned above to obtain a toner image, a transfer device to transfer the toner image to a support for release or a flexible printing medium with a surface roughness of at most 1 μm, and a fixing device to fix the toner image transferred to the support for release or the flexible printing medium.

As another aspect of the present disclosure, an image forming method is provided which contains forming a latent electrostatic image on a latent electrostatic image bearer, developing the latent electrostatic image formed on the latent electrostatic image bearer with a developing agent containing the toner mentioned above to obtain a toner image. transferring the toner image on the latent electrostatic image bearer to a support for release or a flexible printing medium with a surface roughness of at least 1 μm, and fixing the toner image transferred onto the support or the flexible printing medium.

### BRIEF DESCRIPTION OF THE SEVERAL VIEWS OF THE DRAWINGS

A more complete appreciation of the disclosure and many of the attended advantages and features thereof can be readily obtained and understood from the following detailed description with reference to the accompanying drawings wherein:

FIG. 1 is a diagram illustrating a schematic diagram of the image forming apparatus according to an embodiment of the present invention;

FIG. 2 is a diagram illustrating a schematic diagram of a part of an image forming apparatus;

FIG. 3 is a diagram illustrating a schematic diagram of a part of an image forming apparatus; and

FIG. 4 is a typical cross sectional scanning electronic microscopy (SEM) image of a coarsely pulverized product of melt-kneaded mixture of toner compositions of the toner of Example 1 described later.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more the features, integers, steps, operations, elements, components, and/or groups thereof.

Embodiments of the present invention are described in detail below with reference to accompanying drawings. In describing embodiments illustrates in the drawings, specific terminology is employed for the sake of clarity. However, the disclosure of this patent specification is not intended to be limited to the specific terminology so selected. And it is to be understood that each specific element includes all technical equivalents that have a similar function, operates in a similar manner, and achieve a smaller result.

For the sake of simplicity, the same reference number will be given to identical constituent elements such as parts and materials having the same functions and redundant descriptions thereof omitted unless otherwise stated.

Within the context of the present disclosure, if a first layer is stated to be “overlaid” on, or “overlying” a second layer, the first layer may be in direct contact with a portion or all of the second layer, or there may be one or more intervening layers between the first and second layer, with the second layer being close to the substrate than the first layer.

The terms of image forming, recording, and printing in the present disclosure represent the same meaning.

Also, recording media, media, and print substrates in the present disclosure have the same meaning unless otherwise specified.

According to the present disclosure, a toner is provided which possesses sufficient flexibility and sufficiently adheres to a medium made of flexible fibers such as cloth typical toners cannot fix onto.

Fabric is typically flexible and made from fibers in most cases. If toner is used for forming an image on such a flexible fibrous medium, the toner is required to have properties traditional toners for paper media do not have. For example, the toner has to be firmly fixed on fabrics with irregularities and a toner layer is flexible enough to follow the irregularities or the deformation of fabric.

As a result of extensive studies, the present inventors of the present invention have found that by using a toner containing at least 51 percent by mass of a polyurethane resin, the fixability of the toner to fabric media is significantly improved, and an appropriate flexibility is imparted to the fixed toner layer.

On the other hand, in toners having a relatively high true density of at least 1.3 g/cm³ and a relatively large particle size (a volume average particle diameter of at least 9 m), the toner tends to pack easily, resulting in poor conveyability by screws. Furthermore, since such toners are prone to fuse together, a phenomenon known as “screw lock,” in which the toner adheres and solidifies onto the screw during screw conveyance, tends to occur. The present inventors have also investigated this problem of screw lock. As a result, it was found that by controlling the true density, average circularity, volume-average particle diameter, and apparent loose bulk density of the toner within specific ranges, a toner can be obtained that suppresses screw lock, sufficiently fixes to flexible fiber-based media such as fabrics, and possesses adequate flexibility.

One embodiment of the present disclosure provides a toner containing a binder resin, wherein the toner has a true density of from 1.30 to 1.80 g/cm³, an average circularity of less than 0.93, a volume-average particle diameter of from 10 to 30 μm, and an apparent loose bulk density of less than 0.55, wherein the binder resin contains a polyurethane resin, and the content of the polyurethane resin is at least 51 percent by mass based on the toner.

The present disclosure is described in detail below. The embodiments of the present disclosure are not limited to the following descriptions and can be changed within the scope of the present disclosure. In the ranges of (from) a figure A to figure B in the present specification, the figure A and the figure B are both inclusive as the lower limit and the upper limit.

### Toner

The toner of the present embodiment contains a binder resin, wherein the toner has a true density of from 1.30 to 1.80 g/cm³, an average circularity of less than 0.93, a volume-average particle diameter of from 10 to 30 μm, and an apparent loose bulk density of less than 0.55, wherein the binder resin contains a polyurethane resin, and the content of the polyurethane resin is at least 51 percent by mass based on the toner. Accordingly, the toner of the present embodiment can sufficiently fix to flexible fiber-based media such as fabrics, while also exhibiting sufficient flexibility. Furthermore, the toner of the present embodiment can reduce the occurrence of screw lock.

The true density of the toner is 1.30 to 1.80 g/cm³. If the true density of the toner is less than 1.30 g/cm³, restrictions arise in incorporating a large amount of high true density or specific gravity materials (such as white titanium oxide pigment) in order to hide the underlying fabric color. On the other hand, if the true density of the toner exceeds 1.80 g/cm³, the toner tends to pack easily and exhibits poor conveyability, leading to problems such as the toner adhering to conveyance screws.

### Method of Measuring True Density

The term “true density” refers to the density obtained by using only the volume actually occupied by the substance itself as the volume for density calculation. The true density of the toner can be measured using an AccuPyc 111340 apparatus (manufactured by Shimadzu Corporation).

The average circularity of the toner is less than 0.93. If the average circularity of the toner is at least 0.93, the toner particles tend to pack under their own weight. In addition, since the apparent loose bulk density becomes relatively high, in the case of the toner of the present embodiment, which has a relatively large particle size with a volume average particle diameter of 10 to 30 μm, the conveyability of the toner deteriorates, leading to problems such as the toner adhering to conveyance screws. Preferably, the average circularity of the toner is less than 0.90. From the perspective of ensuring fluidity and transferability, it is preferable that the lower limit of the average circularity be 0.80.

### Method of Measuring Average Circularity

The term “average circularity” of the toner refers to (the perimeter of a circle having the same area as the particle projection area/the perimeter of the particle projection image)×100 percent. The average circularity of the toner can be measured using a flow-type particle image analyzer (FPIA®-3000, manufactured by Sysmex Corporation). One example thereof is as follows.

In a 100-mL glass beaker, 0.1 mL to 0.5 mL of a 10 percent by mass surfactant (alkylbenzenesulfonate, Neogen® SC-A, manufactured by Daiichi Kogyo Seiyaku Co., Ltd.) is added, followed by the addition of 0.1 to 0.5 g of toner. The mixture is stirred with a micro-spatula, and then 80 mL of deionized water is added to obtain a liquid dispersion. The liquid dispersion obtained is subjected to ultrasonic dispersion for 3 minutes using an ultrasonic disperser (manufactured by Honda Electronics Co., Ltd.). The measurement sample is then analyzed with an analysis software (FPIA®-3000), and the average circularity of the toner is measured until the particle concentration of the toner reaches 5,000 to 15,000 particles/μL.

In this measurement method, it is required that the particle concentration of the toner in the measurement sample be adjusted to 5,000 to 15,000 particles/μL, from the standpoint of reproducibility in the measurement of average circularity. As in the measurement of toner particle diameter described above, the required amount of surfactant varies depending on the hydrophobicity of the toner. If an excessive amount is added, noise caused by foaming occurs, whereas if an insufficient amount is added, the toner cannot be adequately wetted, resulting in insufficient dispersion. In addition, the required amount of toner to be added varies depending on particle size; a smaller amount is required for fine particles, whereas a larger amount is required for coarse particles. If the volume average particle diameter of the toner is 3 to 10 μm, adjusting the amount of the toner added to 0.1 to 0.5 g makes it possible to achieve a toner concentration in the measurement sample of 5,000 to 15,000 particles/μL.

The volume-average particle diameter of the toner is between 10 μm and 30 μm. A volume-average particle diameter of the toner within this range increases the pile height of the toner layer, making it easier to fill in surface irregularities on flexible media such as cloth. This results in excellent hiding power, which is desirable. Furthermore, considering the trade-off with transferability, the volume-average particle diameter of the toner is preferably no greater than 30 μm.

### Method of Measuring Volume Average Particle Diameter

The volume average particle diameter, i.e., the particle diameter on a volume percent basis, can be measured, for example, using a laser diffraction particle size distribution analyzer (Model “SALD-2300”, manufactured by Shimadzu Corporation). One example thereof is as follows.

In a 100 mL glass beaker, 0.5 mL of a 10 percent surfactant (alkylbenzenesulfonate, Neogen® SC-A, manufactured by Dai-ichi Kogyo Seiyaku Co., Ltd.) was added, followed by the addition of 2 g to 4 g of toner. The mixture is stirred with a micro-spatula, and then 80 mL of deionized water is added to obtain a liquid dispersion. The liquid dispersion obtained is subjected to ultrasonic dispersion for 10 minutes using an ultrasonic disperser (W-113MK-II, manufactured by Honda Electronics Co., Ltd.). The measurement sample was then analyzed using a laser diffraction particle size distribution analyzer to determine the volume average particle diameter.

The apparent loose bulk density of the toner is less than 0.55. A toner with a smaller apparent loose bulk density is less likely to undergo compaction. However, if the apparent loose bulk density of the toner exceeds 0.55, the toner tends to compact, leading to poor conveyability of the toner and problems such as adhesion of the toner to the conveying screw. Preferably, the apparent loose bulk density of the toner is less than 0.50. In view of transferability and fluidity, the lower limit of the apparent loose bulk density is preferably set at 0.35 or more. Specifically, it is preferable that the average circularity of the toner be less than 0.90 and the apparent loose bulk density be less than 0.50. Thus, the toner of the present embodiment can more effectively reduce the occurrence of screw lock.

### Method of Measuring Apparent Loose Bulk Density

A 50 cm³ stoppered graduated cylinder (±0.25 mL, TC 20 degrees Celsius) is pre-weighed, and 14 g of toner was introduced into it. Next, the cylinder is stoppered and shaken manually 10 times to agitate the toner. The cylinder is then left to stand for 10 minutes, and the toner volume is determined. The apparent loose bulk density is then calculated based on the following formula (1):

{(Weight of toner+stoppered graduated cylinder)−(Weight of stoppered graduated cylinder)}/(Volume of toner) (1)

The softening temperature of the toner is preferably less than 40 degrees Celsius. Thus, the toner of the present embodiment can exhibit sufficient flexibility, although this has the side effect of increasing the likelihood of screw lock.

### Method of Measuring Softening Point Ts

The softening point of the toner is measured with a flow tester, CFT-500D, manufactured by Shimadzu Corporation. The toner is pelletized under the minimum pressure at which it could be molded into tablets. The resulting pellets were stored in a thermostatic chamber at 80 degrees Celsius for 30 minutes, and then allowed to cool naturally to room temperature to obtain a toner sample. The softening point Ts of the toner sample was subsequently measured using a flow tester. The flow tester softening point Ts of toner is obtained from the flow curve measured with a flow tester CFT-500, manufactured by Shimadzu Corporation.

The measurement conditions were as follows.
Amount of sample: 1.00±0.05 g
Onset temperature: 40 degrees Celsius
Peak temperature: 200 degrees Celsius
Temperature rising speed: 3.0 degrees Celsius/min
Load for test: 1.96 MPa
Die opening diameter: 0.5 mm
Die length: 1.0 mm

### Binder Resin

The toner of the present embodiment contains a binder resin (fixing resin) containing a polyurethane resin.

Polyurethane resin generally exhibits excellent tensile strength, wear resistance, elasticity, and oil resistance.

The content of the polyurethane resin is at least 51 percent by mass to the toner (the total mass of the toner). More preferably, the content of the polyurethane resin is 51 to 90 percent by mass to the toner.

A polyurethane resin content of at least 51 percent by mass relative to the toner enables sufficient fixation on flexible media such as cloth and also allows the formation of a flexible fixed toner layer. A content of no more than 90 percent by mass maintains the toner's thermal stability and prevents particle agglomeration.

### Confirmation of Presence and Qualification of Resin in Toner

The molecular weight and melting point of the resin may be measured directly for the resin itself. Alternatively, the resin separated from the actual toner using, for example, gel permeation chromatography (GPC), can be subjected to analysis, and the molecular weight, melting point, and mass ratio of the constituent components may be determined by applying the analytical methods described later to each separated component.

One way of separating each component by GPC is as follows.

In GPC measurements using tetrahydrofuran (THF) as the mobile phase, the eluate obtained undergoes preparatory steps, such as fraction collection, followed by the aggregation of fractions corresponding to the desired molecular weight range from the entire elution curve area.

The resulting eluate is subsequently condensed and dried with equipment such as an evaporator. Next, the solid residue is dissolved in a deuterated solvent such as deuterated chloroform or deuterated THF followed by ¹H-NMR measuring. Finally, the ratios of compositional monomers of the resin in the eluted components are calculated based on the integration ratio of each element.

Alternatively, an eluate can be concentrated, followed by hydrolysis using such a substance as sodium hydroxide. The decomposition products obtained are qualitatively and quantitatively analyzed by, for example, high-performance liquid chromatography (HPLC), to calculate the ratio of each compositional monomers.

### Method of Separating Toner's Compositional Component

A method of separating each component for analyzing the toner mentioned above is detailed below.

To begin with, 1 g of toner is placed in 100 mL of THF followed by stirring for 30 minutes at 25 degrees Celsius to obtain a solution in which a soluble portion is dissolved.

This solution is filtered with a 0.2 μm membrane filter to obtain the THD soluble portion in the toner.

Then this soluble portion is dissolved in THF to make a sample for GPC measuring, which is infused into GPC for use in molecular weight measuring of each resin mentioned above.

Simultaneously, a fraction collector is disposed at the exit of the eluate of GPC to separate the eluate by preparatory work by a particular count. An eluate is obtained per 5 percent of the area ratio from the initiation of elution of the elution curve (initial rise of the curve).

Next, 30 mg of each elution is dissolved in 1 mL of deuterated chloroform followed by adding 0.05 percent by volume of tetra methyl silane (TMS) as a reference material. A 5 mm diameter NMR measuring glass tube is filled with this solution followed by 128 time integrations at temperatures of 23 to 25 degrees Celsius using a nuclear magnetic resonance device (JNM-AL400, available from JEOL Ltd.) to obtain spectra.

The monomer compositions and the constitutional ratio of the resins such as polyester resin and urethane resin contained in the toner can be obtained from the peak integrated ratio of the spectra obtained.

For example, peak assignment may be performed as follows, and the composition ratio of the constituent monomers is determined from the respective integration ratios.

The peak assignments may be, for example:
Around 8.25 ppm: Derived from the benzene ring of trimellitic acid (corresponding to 1 hydrogen atom)
Around 8.07 to 8.10 ppm: Derived from the benzene ring of terephthalic acid (corresponding to 4 hydrogen atoms)
Around 7.1 to 7.25 ppm: Derived from the benzene ring of bisphenol A (corresponding to 4 hydrogen atoms)
Around 6.8 ppm: Derived from the benzene ring of bisphenol A (corresponding to 4 hydrogen atoms) and the double bond of fumaric acid (corresponding to 2 hydrogen atoms)
Around 5.2 to 5.4 ppm: Derived from the methine group of bisphenol A propylene oxide adduct (corresponding to 1 hydrogen atom)
Around 3.7 to 4.7 ppm: Derived from the methylene group of bisphenol A propylene oxide adduct (corresponding to 2 hydrogen atoms) and the methylene group of bisphenol A ethylene oxide adduct (corresponding to 4 hydrogen atoms)
Around 1.6 ppm: Derived from the methyl group of bisphenol A (corresponding to 6 hydrogen atoms)

### Analysis of THF-Insoluble Fraction of Toner

The extraction of the THF-insoluble fraction from the toner may be carried out, for example, as follows.

One part of toner is added to 40 parts of THF and refluxed for 6 hours. The insoluble components are then precipitated by centrifugation, and separated from the supernatant. The separated insoluble components are dried at 40 degrees Celsius for 20 hours to obtain the THF-insoluble fraction.

The composition of the THF-insoluble fraction may be analyzed by NMR measurement in solution or solid state, as well as by X-ray diffraction, GC/MS, LC/MS, IR spectroscopy, and other methods.

As a simplified method, pyrolysis simultaneous methylation GC-MS using a methylation reagent may be employed, for example, by the following procedure and conditions:
Instrument: Shimadzu QP2010, Frontier Lab PY2020D
Data analysis software: GCMS solution by Shimadzu
Heating temperature: 280 degrees Celsius
Pyrolysis reaction temperature: 300 degrees Celsius
Column: Ultra ALLOY-5, L=30 μm, ID=0.25 mm, Film=0.25 μm Column: Ultra
ALLOY-5 L=30 μm ID=0.25 mm, Film=0.25 m
Oven temperature: 50 degrees Celsius (hold for 1 min), ramp 10 degrees Celsius/min,
330 degrees Celsius (hold for 11 min)
Carrier gas: He, constant pressure 53.6 kPa, flow rate 1.0 mL/min
Infusion mode: Split (1:100)
Ionization method: EI method (70 eV)
Measurement mode: Scan mode
Library: NIST 20 Mass Spectral Library Measuring mode: Scan modeLibrary: NIST 20 MASS SPECTRAL LIB.

The polyurethane resin preferably includes structural units derived from at least an aliphatic diol, and the glass transition temperature of the polyurethane resin is preferably not higher than 0 degrees Celsius. It is preferable that the polyurethane resin have at least a structural unit derived from an aliphatic diol, and that the glass transition temperature of the polyurethane resin be at most 0 degrees Celsius. This allows the toner of the present embodiment to be sufficiently fixed onto a medium made of flexible fibers such as cloth, while also exhibiting enhanced flexibility.

Specifically, the polyurethane resin preferably contains at least 1,4-butanediol, adipic acid, and diphenylmethane diisocyanate, and has a weight average molecular weight of 40,000 to 130,000. This allows the toner of the present embodiment to be sufficiently fixed onto a medium made of flexible fibers such as cloth, while also exhibiting enhanced flexibility.

The polyurethane resin preferably has a weight average molecular weight of from 40,000 to 130,000, more preferably from 40,000 to 110,000, and furthermore preferably from 40,000 to 100,000. A weight average molecular weight of at least 40,000 prevents a fixed image from running upon ironing it. A weight average molecular weight of at most 130,000 facilitates the melt-kneading of an adhesive with other toner components during toner production.

### Measurement of Weight Average Molecular Weight

The weight average molecular weight of resin for use in the toner can be obtained by measuring the molecular weight distribution for the resin dissolved in tetrahydrofuran (THF) with a GPC measuring device. There is no specific limitation to the GPC measuring device, and it can be suitably selected to suit to a particular application. An example is GPC-150C, available from Waters Corporation.

The column for use in measuring the weight-average molecular weight is not particularly limited and can be suitably selected to suit to a particular application.

Specific examples include, but are not limited to, KF801 (column for organic solvent-based SEC (GPC)), KF802 (column for organic solvent-based SEC (GPC)), KF803 (column for organic solvent-based SEC (GPC)), KF804 (column for organic solvent-based SEC (GPC)), KF805 (column for organic solvent-based SEC (GPC)), KF806 (column for organic solvent-based SEC (GPC)), and KF807 (column for organic solvent-based SEC (GPC)) (all available from Showa Denko K.K.).

The method of measuring the weight average molecular weight of resins for use in the toner is not particularly limited and can be suitably selected to suit to a particular application. One way of measuring is as follows.

THF, used as a solvent, is introduced into a column at a flow rate of 1 mL/min, with the column maintained at 40 degrees Celsius. Then a THF solution containing a sample of 0.05 g is filtered with a pre-processing filter (e.g., Chromatodisk with an aperture of 0.45 μm, available from KURABO INDUSTRIES LTD.) to adjust a sample concentration of from 0.05 to 0.6 percent by mass in the end. A THF sample solution prepared at a predetermined concentration is injected into the column in an amount of 50 to 200 μL in order to separate the THF soluble components contained in the solution. Subsequently, the molecular weight is calculated by using a detector (for example, a refractive index (RI) detector (model: GPC-150C, manufactured by Waters Corporation), thereby allowing measurement of the weight average molecular weight (Mw) of the THF soluble components contained in the THF sample solution.

The weight average molecular weight Mw and the number average molecular weight Mn of the THF dissolved portion in the sample are calculated from the relationship between the count values and the logarithm values of the calibration curves made from several types of monodispersed polystyrene standard samples.

As the standard polystyrene sample for the calibration curve, it is suitable to use at least about ten standard polystyrene samples individually having a molecular weight of 6×10², 2.1×10², 4×10², 1.75×10⁴, 5.1×10⁴, 1.1×10⁵, 3.9×10⁵, 8.6×10⁵, 2×10⁶, or 4.48×10⁶, available from TOSOH CORPORATION or Pressure Chemical Co., for example. A refractive index (RI) detector is preferable as a detector.

There is no specific limitation to procurable polyurethane resins. It can be suitably selected to suit to a particular application. Specific examples include, but are not limited to, hotmelt powder ECOFREEN POWDER, available from ECOFREEN, T8175N, available from DIC Covestro Copolymer Ltd., and P22MBRANAT, available from Nippon Miractan Co., Ltd.).

The binder resin may include polyurethane resin and other optional resins. As the other optional resins, known resins can be used.

Specific examples of the binder resin include, but are not limited to, styrene, styrene-based resins (homopolymers or copolymers of styrene or styrene substitute) such as poly-α-styrene, styrene-chlorostyrene copolymers, styrene-propylene copolymers, styrene-butadiene copolymers, styrene-vinyl chloride copolymers, styrene-vinyl acetate copolymer, styrene-maleic acid copolymer, styrene-acrylic acid ester copolymer, styrene-methacrylic acid ester copolymer, styrene-α-chloroacrylic acid methyl copolymer, and styrene-acrylonitrile-acrylic acid-ester copolymers, epoxy resins, vinyl chloride resins, rosin-modified maleic acid resins, phenol resins, polyethylene resins, polypropylene resins, petroleum resins, polyester resins, ketone resins, ethylene-ethyl acrylate copolymers, xylene resins, and polyvinyl butyrate resins. The method of manufacturing these resins is also not particularly limited. Any of methods such as bulk polymerization, solution polymerization, emulsion polymerization, and suspension polymerization can be utilized.

The binder resin preferably contains a polyurethane resin and polyester resin. Polyester resins can be fixed at low temperatures while maintaining high temperature and high humidity storage stability compared with other resins. For this reason, it is suitable for the toner of the present disclosure as a binder resin.

Preferably, polyester resins are obtained by condensation polymerization of an alcohol and a carboxylic acid. Alcohol to be used is not particularly limited and can be suitably selected to suit to a particular application.

Specific examples include, but are not limited to, glycols such as ethylene glycol, diethylene glycol, triethylene glycol, and propylene glycol, 1,4-bis(hydroxymethyl)cyclohexane, etherified bisphenols such as bisphenol A, diol monomers, tri- or higher polyol monomers.

Carboxylic acid is not particularly limited and can be suitably selected to suit to a particular application.

Specific examples include, but are not limited to, two-valent organic acid monomers such as maleic acid, fumaric acid, phthalic acid, isophthalic acid, terephthalic acid, succinic acid, and moronic acid; and tri- or higher carboxylic acid monomers such as 1,2,4-benzene tricarboxylic acid, 1,2,5-benzene tricarboxylic acid, 1,2,4-cyclohexane tricarboxylic acid, 1,2,4-naphthalene tricarboxylic acid, 1,2,5-hexane tricarboxylic acid, 1,3-dicarboxyl-2-methylene carboxy propane, and 1,2,7,8-octane tetracarboxylic acid.

The polyurethane resin preferably has a softening point Ts of at most 45 degrees Celsius and a tangent method glass transition temperature Tg2nd of at most 45 degrees Celsius. A softening point Ts of at most 45 degrees Celsius and a tangent method glass transition temperature Tg2nd of at most 45 degrees Celsius of the polyurethane resin can afford a flexible fixed toner image.

The polyester resin preferably has both a softening point Ts of at least 60 degrees Celsius and a tangent method glass transition temperature Tg2nd of at least 60 degrees Celsius. A softening point Ts of at least 60 degrees Celsius and a tangent method glass transition temperature Tg2nd of at least 60 degrees Celsius of the polyester resin can afford a toner image with a high temperature storage stability.

In a cross-section of the toner, it is preferable that domains in a sea-island pattern be observed, and more preferably, that discrete portions (domains) of polyester resin be observed within the continuous phase (sea) of polyurethane resin, thereby exhibiting a sea-island structure.

The sea-island structure is constituted of “sea” (also referred to as matrix), a continuous phase of one component of a toner, and “island” (also referred to as domain) of the other components in the “sea”. In the toner, the component present at 51 or more percent by mass forms the continuous phase (“sea”), while the component present at less than 49 percent by mass and immiscible with the sea component exists as discrete, island-shaped domains.

A combination of polyurethane resin with polyester resin can form an incompatible sea-island structure, and the formation of such a structure is facilitated. Therefore, it is preferable to use the polyurethane resin in combination with the polyester resin. If this sea-island structure is not observed in the toner cross-section and the polyurethane resin and polyester resin are in a mutually compatible state, the characteristics inherent to each resin are no longer exhibited, and in particular, the toner image after fixing becomes prone to cracking.

Preferably, the toner of the present embodiment containing a polyurethane resin and a polyester resin has a cross section with a sea-island structure including domains containing the polyester resin and matrix containing the polyurethane resin. Preferably, the domains are incompatible with the matrix.

### Observation of Non-Compatible Domain

The size and shape of the domains in toner can be confirmed by observing backscattered electron images obtained with a scanning electron microscope (SEM). The presence of the sea part (matrix) and the island part (non-compatible domain) in the sea-island structure of toner can be recognized by the color difference. Staining with ruthenium tetroxide may be employed to enhance contrast and facilitate identification of the sea and island regions.

The following procedure and conditions represent an example of backscattered electron image observation using a scanning electron microscope.

The sea-island structure relating to the present embodiment is present in toner particles, even in a coarsely pulverized product of melt-kneaded mixture of toner compositions. For example, a toner particle or a particle of a coarsely pulverized product of melt-kneaded mixture of toner compositions is embedded in epoxy resin and cut out to see a cross section, which is observed with an SEM (SU8230, available from Hitachi Ltd.) under the following conditions. During the observation, the non-stained portions are observed as dark, being distinct from the stained portions, i.e., light portions.
Accelerated voltage: 5 kV
Emission current: 10 μA
Probe current: Norm
Condenser lens 1:5.0
W.D.: 8.0 mm
Observation mode: SE
Magnification: ×2,000 or ×5,000

The toner of the present embodiment may contain a binder resin (resin for fixing) and other optional materials such as a release agent, a colorant, a charge control agent, an external additive, a developing agent, and other components such as a flowability enhancer, a charge control agent, and a magnetic material.

### Release Agent

Any release agent (wax) can be used and selected to suit to a particular application in the toner of the present embodiment. The release agent can be used alone or in combination.

The release agent is not particularly limited and can be suitably selected to suit to a particular application.

Specific examples include, but are not limited to, aliphatic hydrocarbons such as liquid paraffin, microcrystalline wax, natural paraffin, synthetic paraffin, polyolefin wax, and partial oxides, fluorides, and chlorides thereof, animal oil such as beef tallow and fish oil; vegetable oils such as coconut oil, soybean oil, rapeseed oil, rice bran wax, and carnauba wax; higher aliphatic alcohol or aliphatic acid such as montan wax; aliphatic acid amide, aliphatic acid bisamide; metal soap such as zinc stearate, calcium stearate, magnesium stearate, aluminum stearate, zinc oleate, zinc palmitate, magnesium palmitate, zinc myristate, zinc laurate, and zinc behenate; aliphatic acid esters, and polyvinylydene fluoride. Of these, a release agent containing at least ester wax such as fatty acid esters is preferable.

If the toner contains an excessive amount of maleic acid-modified polyolefin having a polypropylene block in its main chain, it may fail to separate from the fixing roller or belt during fixing, resulting in paper jams and waste. This problem can be mitigated by adding an ester wax as a release agent. Moreover, ester wax can be finely dispersed in the toner by the maleic acid modified polyolefin with a polypropylene block in its main chain.

The content of the release agent in the toner is not particularly limited and can be suitably selected to suit to a particular application. It is preferably from 0.1 to 8.0 percent by mass and more preferably from 1.0 to 6.0 percent by mass. If the content is at least 0.1 percent by mass, the toner can be separated from a fixing roller or belt during fixing, reducing the occurrences of waste paper jamming. If the content is at most 8.0 percent by mass, the toner can sufficiently fix on plastic film.

### Colorant

The colorant for use in the toner of the present embodiment is not particularly limited, and any typical colorant can be used. It includes, but is not limited to, black toner, cyan toner, magenta toner, yellow toner, white pigments, green toner, and blue toner.

Black toner is not particularly limited and can be suitably selected to suit to a particular application. Simple carbon black will do, and carbon black, as the main component, with other substances such as copper phthalocyanine is preferable to adjust the hue and luminosity.

Cyan toner is not particularly limited and can be suitably selected to suit to a particular application. Pigment Blue 15:3 as copper phthalocyanine or a mixture of the colorant with aluminum phthalocyanine is preferable.

Magenta toner is not particularly limited and can be suitably selected to suit to a particular application.

Specific examples include, but are not limited to, Pigment Red 53:1, Pigment Red 81, Pigment Red 122, Pigment Red 269, and a mixture thereof.

Yellow toner is not particularly limited and can be suitably selected to suit to a particular application.

Specific examples include, but are not limited to, Pigment Yellow 74, Pigment Yellow 155, Pigment Yellow 180, Pigment Yellow 185, and a mixture thereof. Using simple Pigment Yellow 185 or a mixture of Pigment Yellow 185 with Pigment Yellow 74 is preferable to enhance saturation and storage stability.

White pigment is not particularly limited and can be suitably selected to suit to a particular application. For example, titanium dioxide surface treated with a substance such as silicon, zirconia, aluminum, and polyol can be used.

Green toner is not particularly limited and can be suitably selected to suit to a particular application. For example, Pigment Green 7 can be used with a care for safety.

Blue toner is not particularly limited and can be suitably selected to suit to a particular application. It includes, but is not limited to, Pigment Blue 15:1 and Pigment Violet 23.

If the toner of the present embodiment is used as an underlying layer (i.e., the layer formed closest to the support-for-release or the printing medium) and a typical toner layer is formed thereon as an upper layer, the typical toner can also be effectively fixed onto cloth media with significant fiber irregularities.

In addition, since the toner of the present embodiment has rubber elasticity, the printed toner image is not likely to crack, demonstrating resistance to expanding, bending, and laundering. In order not to affect the hue of the toner image formed on the underlying layer along with this property of the toner, the toner of the present embodiment used to form the underlying layer preferably contains a white colorant or is colorless (i.e., containing no colorant). If the colorant in the toner is white, it is preferable, from the standpoint of maintaining the color tone of the overlaid toner, that the colorant content be within the range of 10 to 50 percent by mass, relative to a total toner mass of 100 percent. If the content of the white colorant is less than 10 percent by mass, the hiding power of the underlying layer may be insufficient. Conversely, if the content exceeds 50 percent by mass, the resin content in the toner may become insufficient, leading to reduced image strength.

### Charge Control Agent

The toner of the present embodiment may optionally contain a charge control agent.

The charge control agent is not particularly limited and can be suitably selected to suit to a particular application.

Specific examples include, but are not limited to, modified products such as nigrosine and metal salts of aliphatic acids; onium salts such as phosphonium salts and lake pigments thereof, triphenylmethane dyes and lake pigments thereof, metal salts of higher aliphatic acids; diorganotin oxides such as dibutyltin oxide, dioctyltin oxide and dicyclohexyltin oxide; diorganotin borates such as dibutyltin borate, dioctyltin borate, dicyclohexyltin borate; organometallic complexes, chelate compounds, monoazo metal complexes, acetylacetone metal complexes, metal complexes of aromatic hydroxycarboxylic acids and aromatic dicarboxylic acid; and quaternary ammonium salts. Other examples include, but are not limited to, aromatic hydroxycarboxylic acid, aromatic mono- and polycarboxylic acid and their metal salts, anhydrides, esters, and phenol derivatives such as bisphenol. These can be used alone or in combination.

The amount of the charge control agent internally added to the electrophotographic toner is not particularly limited and may be suitably selected according to an intended application. Preferably, the amount is in the range of 0.1 to 10 percent by mass based on the total mass of the binder resin. Preferably, the charge control agent is totally or almost transparent to prevent the charge control agent from coloring the toner except for black toner.

### External Additive

The toner of the present embodiment can use substances such as inorganic fine particles (inorganic particulates) as external additives.

The inorganic particulates externally added to the toner are not particularly limited and can be suitably selected to suit to a particular application.

Specific examples include, but are not limited to, silica, alumina, titanium oxide, barium titanate, magnesium titanate, calcium titanate, strontium titanate, zinc oxide, silica sand, clay, mica, wollastonite, diatomaceous earth, chromium oxide, cerium oxide, iron oxide, antimony trioxide, magnesium oxide, zirconium oxide, barium sulfate, barium carbonate, calcium carbonate, silicon carbide, and silicon nitride. Of these, silica, alumina, and titanium oxide are preferable.

This inorganic fine particle may be surface-treated with a hydrophobizing agent. The hydrophobizing agent is not particularly limited and can be suitably selected to suit to a particular application. Examples include, but are not limited to, silane coupling agents, silylating agents, silane coupling agents with a fluorinated alkyl group, organic titanate-based coupling agents, and aluminum-based coupling agents. Moreover, the use of silicone oil as a hydrophobizing agent yields sufficient performance.

The average diameter of the primary particle of the inorganic fine particles is not particularly limited and can be suitably selected to suit to a particular application. It is preferably 5 to 500 nm and more preferably from 5 to 200 nm.

An average diameter of at least 5 nm inhibits the agglomeration of inorganic fine particles, uniformly dispersing the inorganic fine particles in the toner. An average diameter of 500 or less nm can enhance the thermal storage stability through the filler effect. The average particle diameter is determined by directly measuring the particle size from a transmission electron microscope (TEM) image. It is preferable to measure at least 100 particles and use the average of their major diameters.

### Developing Agent

The toner of the present embodiment can be mixed with a carrier to form a developing agent. In other words, the developing agent contains the toner of the present embodiment along with optional components such as a carrier. Using this developing agent, an underlying layer with excellent fixability can be formed on the surface of the fabric.

The developing agent may be either a one-component or a two-component type. In view of its longer service life, the two-component developing agent is preferable for high-speed printers designed to accommodate recent advances in information processing.

When the toner of the present embodiment is used as a one-component developing agent, it exhibits little variation in particle size even after toner replenishment. Owing to this stability, the toner is less likely to form a film on the developing roller or fuse onto members such as a blade for forming a thin toner layer. Accordingly, even under prolonged agitation in the developing device, good and stable

The toner of the present embodiment can be mixed with a carrier to form a two-component developing agent, which can be used in an electrophotographic image forming method employing a two-component developing system. When the toner of the present embodiment is used as a two-component developing agent, it exhibits little variation in particle size even after prolonged toner replenishment, and good, stable developability and image quality can be obtained even during long-term agitation in the developing device.

### Magnetic Material

The magnetic fine particle (particulate) for use in magnetic carrier used in a two-component developing agent is not particularly limited and can be suitably selected to suit to a particular application.

Examples of the magnetic particulates include, but are not limited to, spinel ferrites such as powdered iron, magnetite, and gamma ferric oxide, spinel ferrites containing one or two types of non-iron metals such as Mn, Ni, Zn, Mg, and Cu, magnetoplumbite type ferrites such as barium ferrite, and iron or alloyed metal particles with an oxidized layer on the surface. Of these, white materials are preferable in terms of color tone.

The magnetic particulate includes a granular, spherical, or acicular magnetic particulate. Using ferromagnetic particulates such as iron is preferable to obtain a strongly magnetized carrier.

Of these, spinel ferrite such as magnetite and gamma ferric oxide and magnetoplumbite type ferrite such as barium ferrite are preferable to be chemically stable. Specific examples include, but are not limited to, MFL-C 35S, MFL-C 35HS (available from Powdertech CO., Ltd.), DFC-C 400M, DFC-C 410M, and SM-C 350NV (available from Dowa IP Creation Co., Ltd.).

A resin carrier with a desired magnetization can be used depending on the type and content of a ferromagnetic particle (carrier). Preferably, such a resin carrier has a magnetization of from 30 to 150 emu/g in 1,000 oersted.

Such resin carriers can be manufactured by spraying a melt-kneaded material containing magnetized particulates and an insulating binder resin with a spray drier. Also, it is possible to manufacture a resin carrier by reacting and curing monomers or prepolymers in an aqueous medium under the presence of magnetized particulates. The resin carrier obtained has magnetized particulates (carriers) dispersed in a condensation type binder.

The magnetized carrier can be coated with resin or have positively or negatively charged particulates or electroconductive particulates fixated on the surface of the magnetized carrier to control the chargeability.

The coating material (resin) for the surface of the magnetized carrier includes, but is not limited to, silicone resins, acrylic resins, epoxy resins, and fluorochemical resins. Furthermore, the coating may contain positively or negatively charged or electroconductive particulates. Of these, silicone resins and acrylic resins are preferable.

The mass ratio of the carrier to the developing agent accommodated in a developing device is preferably 85 to less than 98 percent by mass.

A mass ratio of the carrier to a developing agent of at least 85 parts by mass reduces toner scattering from a developing device and decreases the production of defective images. A mass ratio of the carrier to the developing agent of less than 98 percent by mass inhibits an extreme increase in the charge size of the electrophotographic developing toner and minimizes toner supply shortages, thereby reducing the occurrence of defective images due to decreased image density.

### Flowability Enhancer

The toner of the present embodiment may contain a flowability enhancer as an additive. The flowability enhancer is not particularly limited, provided that it is surface-treated to increase hydrophobicity and can prevent deterioration of flow characteristics or chargeability even under high humidity, and may be appropriately selected according to an intended purpose.

Specific examples of the flowability enhancer include, but are not limited to, silane coupling agents, silylation agents, silane coupling agents including a fluoroalkyl group, organic titanate coupling agents, aluminum coupling agents, silicone oils, and modified silicone oils.

If used as external additives, silica and titanium oxide are preferably employed in hydrophobized form, obtained by surface treatment with a flowability enhancer such as those exemplified above.

### Cleaning Improver

The toner of the present embodiment may contain a cleaning improver as an additive. The cleaning improver is not particularly limited, as long as it can be added to the toner of the present embodiment for the purpose of removing the developing agent remaining on the electrostatic latent image bearing member or the primary transfer medium after transfer, and may be appropriately selected according to the intended purpose.

Specific examples of the cleaning improver include, but are not limited to, metal salts of fatty acids such as zinc stearate, calcium stearate, and stearic acid, as well as polymer particles produced by soap-free emulsion polymerization, such as polymethyl methacrylate fine particles and polystyrene fine particles. The polymer fine particles preferably have a relatively sharp particle size distribution and its volume average particle diameter is preferably from 0.01 to 1 μm.

### Method of Manufacturing Toner

The method of manufacturing the toner is not particularly limited and can be suitably selected to suit to a particular application. One way of manufacturing the toner of the present embodiment is described below.

One embodiment of the method of manufacturing the toner includes obtaining a binder resin mixture (mixing process), obtaining a kneaded substance of the mixture (melt-kneading process), obtaining a solid of kneaded substance (solidifying process), and obtaining a pulverized substance of the solid (finely pulverizing process), and classifying and collecting the pulverized substance (classifying process).

### Obtaining Mixture of Binder Resin (Mixing Process)

A binder resin, a colorant, a release agent, and optional substances such as a charge control agent are mixed with a mixer to obtain a mixture (mixing process).

The mixer is not particularly limited and can be suitably selected to suit to a particular application. Examples include, but are not limited to, a Henschel Mixer (FM20B, available from NIPPON COKE & ENGINEERING. CO., LTD.) and a super mixer (SMV-20Ba, available from KAWATAMFG Co., Ltd.).

### Obtaining Melt-Kneaded Product of Mixture

Then the mixture obtained is melt-kneaded using a hot melt-kneading machine to obtain a kneaded substance (melt-kneading process).

There are no particular limitations on the hot melt-kneading machine, and it may be appropriately selected according to a particular application.

Specific products available from the market include, but are not limited to, a two-screw extruder (PCM series, available from IKEGAI CORPORATION), a TEM extruder (available from SHIBAURA MACHINE CO., LTD.), a two-screw extruder PCM kokneader, available from Buss AG, and an open roll continuous kneader (KNEADEX, available from NIPPON COKE & ENGINEERING. CO., LTD.), and a batch kneader (WONDER KNEADER, WDS7-30, manufactured by moriyama).

### Obtaining Solidified Product of Melt-Kneaded Product

Then the kneaded substance obtained is cooled and solidified to yield a solid product (solidifying process). The cooling and solidification methods are not particularly limited and can be appropriately selected according to an intended purpose. One way of cooling and solidifying the molten kneaded material is to extrude it through a 3 mm diameter die using a feeder-loader to form strands, which are then cooled in a water tank at a temperature of at most 15 degrees Celsius. The solidified strands are then cut using a pelletizer to obtain toner pellets.

### Obtaining Pulverized Product of Solid (Fine Pulverization Process)

Subsequently, the obtained solid product is finely pulverized to yield a pulverized material (fine pulverization process). The solid product may be pulverized using known pulverization methods: For example, a jet mill method, in which toner is entrained in a high-speed airflow and pulverized by the energy of impact against a collision plate; a particle collision method, in which toner particles collide with each other in an airflow; a mechanical pulverization method, in which toner is fed into a narrow gap between a high-speed rotating rotor and a stator; and a cyclone mill pulverization method, in which two impellers are rotated to generate a high-speed airflow, thereby producing shear forces for pulverization. Since the toner of the present embodiment is difficult to pulverize at room temperature, it is preferable to cool the obtained solid product (pellets) using liquid nitrogen in a cooling device, and then pulverize it using a mechanical pulverizer, a cyclone mill pulverizer, the Linrex Mill LX (manufactured by Hosokawa Micron Corporation).

### Classifying and Collecting Pulverized Material (Classifying Process)

Next, the pulverized material is classified, and the classified material with a particular volume average particle diameter are collected. A toner is thus obtained (classifying process). The classifying method is not particularly limited and can be suitably selected to suit to a particular application. Toners can be classified by any classification method.

The toner of the present embodiment can be manufactured by a suspension of solution and solvent removal method. In the suspension of solution and solvent removal method, an oil phase, in which toner materials containing a binder resin, a colorant, a release agent, and other optional materials such as a charge control agent are dissolved or dispersed, is dispersed in an aqueous medium (aqueous phase) to allow the binder resin to react. This reaction affords a liquid dispersion containing a dispersion (oil droplets) containing a prepolymer of emulsified or dispersed toner materials. Thereafter, the organic solvent is removed from the liquid dispersion, followed by filtering, rinsing, drying, and optional processes such as classifying. Mother toner particles are thus obtained. The toner of the present embodiment is obtained by granulating the mother particles obtained by a suspension of solution and solvent removal method.

The organic solvent is not particularly limited and can be suitably selected to suit to a particular application. An organic solvent with a boiling point of lower than 150 degrees Celsius is preferable because it is easy to remove.

There is no specific limitation to the selection of the organic solvents with a boiling point of lower than 150 degrees Celsius and can be suitably selected to suit to a particular application. Specific examples include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These can be used alone or in combination.

Of these, ethyl acetate, toluene, xylene, benzene, methylene chloride, 1,2-dichloroethane, chloroform, and carbon tetrachloride are preferable and ethyl acetate is particularly preferable.

The aqueous medium is not particularly limited and can be suitably selected to suit to a particular application. It includes, for example, water, a solvent miscible with water, and a mixture thereof. These can be used alone or in combination. Of these, water is preferable.

The solvent miscible with water is not particularly limited and can be suitably selected to suit to a particular application. It includes, for example, alcohol, dimethyl formamide, tetrahydrofuran, cellosolves, and lower ketones.

Alcohol is not particularly limited and can be suitably selected to suit to a particular application. It includes, for example, methanol, isopropanol, and ethylene glycol.

Lower ketones are not particularly limited and can be suitably selected to suit to a particular application. It includes, for example, acetone and methylethyl ketone.

The method of removing the organic solvent from a liquid dispersion is not particularly limited and can be suitably selected to suit to a particular application. It includes, for example, a method of evaporating the organic solvent in oil droplets by gradually heating the entire reaction system and a method of spraying a liquid dispersion in dried atmosphere to remove the organic solvent in oil droplets.

Classification in the suspension of solution and solvent removal method can be carried out by removing fine particles in liquid with a cyclone, decanter, or centrifuge or performed after drying a liquid dispersion.

### Toner Set

The toner set of the present embodiment contains a color toner containing a binder resin and a colorant and the toner of the present embodiment. Accordingly, the toner set of the present embodiment can sufficiently fix on flexible fiber-based media such as fabrics, while also exhibiting sufficient flexibility. Furthermore, the toner set of the present embodiment can reduce the occurrence of screw lock.

The color toner is not particularly limited and can be selected among known color toners. The binder resin in a color toner is not particularly limited and can be suitably selected to suit to a particular application. This binder resin can be the same as that in the toner according to the present embodiment. The colorant is not particularly limited and can be suitably selected among known colorants to suit to a particular application.

The toner set mentioned above is loaded in an image forming apparatus described later and used to form images. The toner of the present embodiment is used for image forming. Therefore, images can be formed reflecting the toner's excellent fixability on cloth.

### Image Transfer Sheet

The image transfer sheet of the present embodiment includes a support for release and an image created with the toner of the present embodiment on the support. This image transfer sheet allows the toner to be sufficiently fixed onto a medium made of flexible fibers such as cloth, while also exhibiting enhanced flexibility.

The support for release acting as a transfer medium of an image can be any sheet-like material on which an image can be formed.

Specific examples include, but are not limited to, cardboard, a postcard, a roll of paper, an envelope, plain paper, thin paper, coated paper (typically coated paper and art paper), tracing paper, a transparent sheet, a transparent film, and a resin film as a support for release. The support for release may be a flexible recording medium such as cloth. Further, from the viewpoint of releasability, it is preferable that the support for release have a release layer present on its surface. It is also preferable that the support for release have a layer formed on its surface containing at least a silicone component or a fluorine component.

### Toner Accommodating Unit

The toner accommodating unit of the present embodiment includes a unit for accommodating toner and the toner of the present embodiment in the unit. According to the toner accommodating unit of the present embodiment, the toner is sufficiently flexible and fixable on a medium made from flexible fibers such as cloth. Furthermore, the toner accommodating unit of the present embodiment can reduce the occurrence of screw lock.

The form of the toner accommodating unit is not particularly limited and can be suitably selected to suit to a particular application. Examples include, but are not limited to, units such as a toner accommodating container, a developing device, and a process cartridge.

The toner accommodating container is a vessel containing a toner. The toner accommodating container may be also referred to as a developing agent accommodating container if the toner is used as a developing agent. The developing agent container is not particularly limited and can be suitably selected from known containers, one of which includes a vessel and a cap or lid.

The toner accommodating container and the developing agent accommodating container vary in size, structure, and materials and are not particularly limited and can be suitably selected to suit to a particular application.

The shape of the vessel of the developing agent accommodating container is not particularly limited and can be suitably selected to suit to a particular application. Preferably, it is a cylinder with irregularities spirally formed on its inner surface. The developing agent, as a content in a vessel, quickly moves towards the vessel's exit following the rotation of the vessel. Preferably, all or part of the irregularities form a bellow-like shape. Due to such a bellow-like structure, the developing agent moves towards the exit more quickly.

The material of the toner accommodating container and the developing agent accommodating container is not particularly limited and it can be suitably selected to suit to a particular application. A resin such as polyester resin, polyethylene resin, polypropylene resin, polystyrene resin, polyvinyl chloride resin, polyacrylic acid, ABS resin containing a polycarbonate resin component, or polyacetal resin is preferably used to obtain good dimensional accuracy.

The toner container and the developing agent container are easy to store and transport, and excellent in handling. They can be detachably attached to an image forming apparatus or a process cartridge, which will be described later, and can be used for replenishing toner or developing agent.

The developing unit refers to a device that accommodates toner and develops with the toner. The process cartridge includes at least a latent electrostatic image bearer integrated with a developing device, accommodates toner, and is detachably attachable to an image forming apparatus. The process cartridge may furthermore include at least one member selected from the group consisting of a charger, an exposure (quencher, discharger), and a cleaning device.

By mounting the toner accommodating unit of the present embodiment in the image forming apparatus of the present embodiment and performing image formation, image formation is carried out using the toner of the present embodiment, thereby enabling image formation with toner having excellent fixability to cloth.

### Image Forming Method and Image Forming Apparatus

The image forming apparatus of the present embodiment includes a latent electrostatic image bearer, a latent electrostatic image forming device for forming a latent electrostatic image on the latent electrostatic image bearer, a developing device for developing the latent electrostatic image formed on the latent electrostatic image bearer with a developing agent containing the toner of the present disclosure to obtain a toner image, a transfer device for transferring the visible image onto a support for release or flexible printing medium with a surface roughness of at least 1 μm, a fixing device for fixing the toner image transferred onto the support or flexible printing medium. With this configuration, the image forming apparatus of the present embodiment allows the toner to be sufficiently fixed to flexible fiber-based media such as cloth, while retaining sufficient flexibility. Furthermore, the image forming apparatus of the present embodiment can reduce the occurrence of screw lock.

The image forming apparatus of the present embodiment may furthermore optionally include other devices.

The image forming method of the present embodiment includes forming a latent electrostatic image on a latent electrostatic image bearer, developing the latent electrostatic image formed on the latent electrostatic image bearer with a developing agent containing the toner of the present embodiment to obtain a toner image, transferring the toner image on the latent electrostatic image bearer overlying a support for release or a flexible printing medium with a surface roughness of at least 1 μm; and fixing the toner image transferred onto the support or the flexible printing medium. With this configuration, the image forming method of the present embodiment allows the toner to be sufficiently fixed to flexible fiber-based media such as cloth, while retaining sufficient flexibility. Furthermore, the image forming method of the present embodiment can reduce the occurrence of screw lock.

In the image forming method of the present embodiment, a toner image is formed using the toner of the present embodiment, and other processes may be optionally included.

The image forming apparatus of the present embodiment suitably executes the image forming method of the present embodiment. The latent electrostatic image forming device suitably executes the process of forming a latent electrostatic image. The developing device suitably carries out the process of developing. The transferring device suitably conducts the process of transferring. The fixing device suitably performs the process of fixing. The other optional devices suitably conduct the optional processes.

### Latent Electrostatic Image Bearer

The size and structure of the latent electrostatic image bearer is not particularly limited, and it can be suitably selected among the devices known in the art to suit to a particular application.

There is not specific limitation on the materials of the latent electrostatic image bearer, and it can be suitably selected to suit to a particular application.

Specific examples include, but are not limited to, inorganic compounds such as amorphous silicon and selenium for an inorganic photoconductor and organic compounds such as polysilane and phthalopolymethine for an organic photoconductor (OPC).

The latent electrostatic image bearer is not particularly limited and can be suitably selected to suit to a particular application. A latent electrostatic image bearer having a cylindrical form is preferable. The outer diameter of a cylindrical photoconductor is not particularly limited and can be suitably selected to suit to a particular application. It is preferably from 3 to 100 mm, more preferably from 5 to 50 mm, and furthermore preferably from 10 to 30 mm.

### Latent Electrostatic Image Forming Device and Latent Electrostatic Image Forming Process

The latent electrostatic image forming device is not particularly limited and can be suitably selected to suit to a particular application as long as it can form a latent electrostatic image on the latent electrostatic image bearer. The latent electrostatic image forming device includes at least a charger that uniformly charges the surface of the image bearer and an irradiator that irradiates the surface of the image bearer in accordance with the image information obtained.

Latent electrostatic images are formed on the latent electrostatic image bearer in the latent electrostatic image forming process in the image forming method of the present embodiment. The latent electrostatic image forming process includes charging the surface of the latent electrostatic image bearer and irradiating the charged surface with beams of light to form a latent electrostatic image.

There is no particular limit to the charging process, and it can be suitably selected to suit to a particular application. For example, this process can be executed with a charger for applying a bias to the surface of a latent electrostatic image bearer.

There is no particular limit to the irradiating process, and it can be suitably selected to suit to a particular application. For example, this process can be executed with an irradiator for irradiating the surface of a latent electrostatic image bearer imagewise with beams of light.

There is no particular limit to the forming a latent electrostatic image, and it can be suitably selected to suit to a particular application. Latent electrostatic images are formed by, for example, uniformly charging the surface of a latent electrostatic image bearer and irradiating the surface according to the obtained image information using a latent electrostatic image forming device.

### Charging Device

The charging device (charger) is not particularly limited and can be suitably selected to suit to a particular application.

Specific examples include, but are not limited to, a contact type charger that includes an electroconductive or semiconductive roll, brush, film, or a rubber blade, and a non-contact type charger using corona discharging such as corotron and scorotron.

The charger may employ a roller form and any other form such as a magnetic brush and a fur brush, and can be selected according to the specification or form of an image forming apparatus.

Preferably, the charger is disposed in contact or non-contact with the latent electrostatic image bearer and applies a direct voltage and an alternating voltage superimposed thereon to the surface of the latent electrostatic image bearer. The charger is preferably a charging roller disposed in contact with the latent electrostatic image bearer with a gap tape therebetween. It is also preferable that the charging roller apply a direct voltage on which an alternate voltage is superimposed to charge the surface of the latent electrostatic image bearer.

The charger is not particularly limited to the contact type charging device, but is preferable because such a charger contributes to manufacturing an image forming apparatus producing less amount of ozone.

### Irradiating Device (Irradiator)

The irradiator is not particularly limited and can be suitably selected to suit to a particular application as long as it can irradiate the surface of a latent electrostatic image bearer charged with the charger imagewise.

Specific examples include, but are not limited to, a photocopying optical system, a rod lens array system, a laser optical system, and a liquid crystal shutter optical system.

The light source for the irradiator has no particular limit and can be suitably selected to suit to a particular application. Specific examples include, but are not limited to, typical luminous materials such as a fluorescent lamp, a tungsten lamp, a halogen lamp, a mercury lamp, a sodium lamp, a light emitting diode (LED), a semiconductor laser (LD), and electroluminescence (EL).

Variety of optical filters can be used to irradiate a latent electrostatic image bearer with beams of light having only a desired wavelength.

It includes, but is not limited to, a sharp cut filter, a band-pass filter, a near infrared filter, a dichroic filter, a coherent filter, and a color conversion filter.

The dorsal irradiation system, in which a latent electrostatic image bearer is irradiated from its rear side can be also employed.

### Developing Device and Developing Process

The developing device is not particular limited and can be suitably selected to suit to a particular application as long as it can develop a latent electrostatic image formed on a latent electrostatic image bearer to form a toner image. The developing device preferably includes, for example, a developing unit for accommodating toner and applying the toner to a latent electrostatic image in a contact or non-contact manner. The developing unit preferably includes a container containing the toner.

In the developing process in the image forming method of the present embodiment, a toner image is formed by sequentially developing a latent electrostatic image with multiple color toners. The toner image is formed by, for example, developing the latent electrostatic image with the toner using the developing unit.

In the developing process, the toner relating to the present embodiment is used. Preferably, the toner of the present embodiment is used in the image forming method. Toner images can be formed with a developing agent containing the toner and another optional component such as a carrier.

In addition, the developing unit may be a single color or multi-color developing device. Preferably, the developing unit includes a stirrer for triboelectrically charging toner, a magnetic field generator fixed inside, and a rotatable developing agent bearer that bears a developing agent containing the toner on its surface.

In the developing unit, for example, the toner and the carrier are mixed and agitated to charge the toner due to the friction therebetween. The toner is held on the surface of the rotating magnet roller, forming a magnet brush like a filament. Since the magnet roller is provided near the latent electrostatic image bearer, some toner forming the magnet brush on the magnet roller's surface is electrically attracted to the surface of the latent electrostatic image bearer. As a result, the latent electrostatic image is developed with the toner and rendered visible with the toner on the surface of the latent electrostatic image bearer.

The image forming apparatus of the present embodiment can include a total of five developing devices for color toners (black, cyan, magenta, and yellow) and for the toner of the present embodiment. The toner of the present development may adopt any color, preferably colorless or white. The toner according to an embodiment of the present embodiment can be all or a part of the color toners of black, cyan, magenta, and yellow used in the developing device.

### Transfer Device and Transfer Process

The transfer device preferably includes a primary transfer device for transferring a toner image to an intermediate transfer body to form a complex transfer image and a secondary transfer device for transferring the complex transfer image to a support for release or a flexible printing medium. The intermediate transfer body is not particularly limited and can be suitably selected from the known transfer members including a transfer belt.

In the transferring process executed by the image forming apparatus of the present embodiment, a toner image is transferred to a support for release or a flexible printing medium. In the transferring process, it is preferable to primarily transfer a toner image onto an intermediate transfer body, from which the toner image is secondarily transferred to a support for release or a flexible printing medium.

More preferably, the transferring includes primarily transferring toner images formed with two or more color toners, preferably full color toners, onto an intermediate transfer body, where each toner image is overlapped to form a complex transfer image and secondarily transferring the complex transfer image onto a support for release or a flexible printing medium,

The toner image is transferred by, for example, charging the latent electrostatic image bearer with the transfer charging unit in the transfer device.

The transfer device (the primary transfer device and the secondary transfer device mentioned above) preferably includes at least a transfer unit for peeling-charge the toner image formed on a latent electrostatic image bearer to transfer a toner image to a support for release or a flexible printing medium. One or more transfer devices can be provided.

Specific examples of the transfer device include, but are not limited to, a corona transfer unit using corona discharging, a transfer belt, a transfer roller, a pressure transfer roller and an adhesive transfer device.

There is no particular limitation on the support for release, and it can be suitably selected to suit to a particular application. A typical example of the support for release is release paper. However, the support for release includes any paper to which a non-fixed developed image can be transferred, so plain paper and PET base for an overhead projector can be also used.

A typical example of the flexible printing medium having a surface roughness of at least 1 μm is cloth, which is not particularly limited and can be suitably selected to suit to a particular application as long as a non-fixed developed image can be transferred. It includes, but is not limited to, woven cloth made from fiber and non-woven cloth.

It is preferable that the image thickness printed on the support for release or the flexible printing medium be 50 to 150 μm, and more preferably 50 to 100 μm. If the image thickness is under 50 μm, cracks tend to appear on the image from expansion and contraction. If it is over 150 μm, the image becomes stiff, and on garments like T-shirts, the hardened print makes them uncomfortable to wear. Further, when the image thickness exceeds 150 μm, the toner is more likely to offset.

The image thickness can be measured by taking a magnified cross-sectional photograph of the image using a microscope.

### Fixing Device and Fixing Process

As the fixing member, there is no specific limitation to it and it can be suitably selected to suit to a particular application. Using a known heating and pressure member is preferable. The heating and pressing device includes, but is not limited to, a combination of a heating roller and a pressing roller or a combination of a heating roller, a pressing roller, and an endless belt can be suitably used.

The fixing process executed by the image forming apparatus of the present embodiment fixes a toner image transferred onto a support for release or a flexible printing medium using a fixing device.

This process may be performed each time a developing agent of a respective color is transferred onto the support for release or the flexible recording medium, or may be performed simultaneously in a stacked state after all developing agents of respective colors have been transferred.

The fixing device includes a heating body equipped with a heat-generating member, paper or release paper brought into contact with the heating body, and a pressing member for pressing the heating body via the paper or release paper therebetween. It is preferably a heating and pressing unit that melt-fixes a non-fixed image on a support for release or a flexible printing medium at the passing of support or medium between the pressing member and the heating body.

There is no specific limit to the heating temperature at the heating and pressing unit, and it can be suitably selected to suit to a particular application. Preferably, the temperature is from 80 to 200 degrees Celsius.

The surface pressure at the pressure and heat applied portion is not particularly limited and can be suitably selected to suit to a particular application. Preferably, it is from 10 to 80 N/cm².

In the present embodiment, a fixing device such as a known optical fixing device can be used along with or instead of the fixing device.

In addition to the fixing unit of the image forming apparatus, a commercially available household iron or a commercial iron press (such as the manually operated heat press PHP-MS233 manufactured by Piotec Co., Ltd.) may be used as the fixing unit. In this case, during the fixing process, a medium such as fabric is placed over the toner image on the support for release, and further a release paper is placed thereon, followed by application of heat and pressure. The heat and pressure are selected to appropriate values based on the thermal properties of the toner, the type of fabric, and the thickness of the fabric. Subsequently, the release paper and the support for release are peeled off, and the toner image is thermally transfer-fixed onto the fabric such as cloth. Thereafter, optionally release paper is placed again over the toner image and heat and pressure are reapplied to finish and fix the toner image

### Other Optional Device and Other Optional Process

The image forming apparatus of the present embodiment may furthermore optionally include other devices such as a quencher, a cleaner, a recycling device, and a control device.

The image forming method of the present embodiment may furthermore optionally include other processes such as quenching, cleaning, and recycling.

### Quenching Device and Quenching Process

The quenching device (quencher) is not particularly limited as long as it can apply a quenching bias to a latent electrostatic image bearer. It can be selected among the known quenchers, including a quenching lamp.

In the quenching (discharging) process, a quencher (discharging device) applies a discharging bias to the latent electrostatic image bearer.

### Cleaner and Cleaning Process

The cleaner is not particularly limited and can be suitably selected among known cleaners to suit to a particular application as long as it can remove remaining on a latent electrostatic image bearer. It includes, but is not limited to, a magnetic brush cleaner, an electrostatic brush cleaner, a magnetic roller cleaner, a blade cleaner, a brush cleaner, and a web cleaner.

In the cleaning process, toner remaining on the surface of a latent electrostatic image bearer is removed, which can be suitably conducted with a cleaner.

The image forming apparatus of the present embodiment can enhance cleanability due to the cleaning device included in the image forming apparatus. Specifically, by controlling the adhesion between toner particles, the toner's flowability is regulated, leading to improved cleaning performance.

In addition, controlling the properties of degraded toner achieves a long-working life or maintains the excellent cleaning performance even in a severe condition such as a high temperature and high moisture environment. Moreover, since the external additive can be sufficiently isolated from the toner on a latent electrostatic image bearer, the external additive accumulates at the nipping portion of the cleaning blade, forming dam layers and demonstrating good cleanability.

### Recycling Device and Recycling Process

The recycling device is not particularly limited and can be suitably selected among conveyors known in the art to suit to a particular application.

The recycling process is to return the toner removed in the cleaning process to the developing device for recycling and can be conducted by the recycling device mentioned above.

### Controller

The control device controls the behaviors of individual devices mentioned above. There is no specific limit to the control device, and any controller can be suitably selected to suit to a particular application as long as it can control the behavior of each device. For example, controlling device such as a sequencer and a computer are preferable.

The image forming apparatus of the present embodiment uses the toner described herein to provide images with excellent fixability on flexible media such as cloth. This excellent fixability not only enables stable high-quality image output, but also contributes to reduced power consumption.

The image forming method of the present embodiment enables image formation using the toner described herein, thereby providing images with excellent fixability on flexible media such as fabric. This improved fixability contributes to the stable production of high quality images.

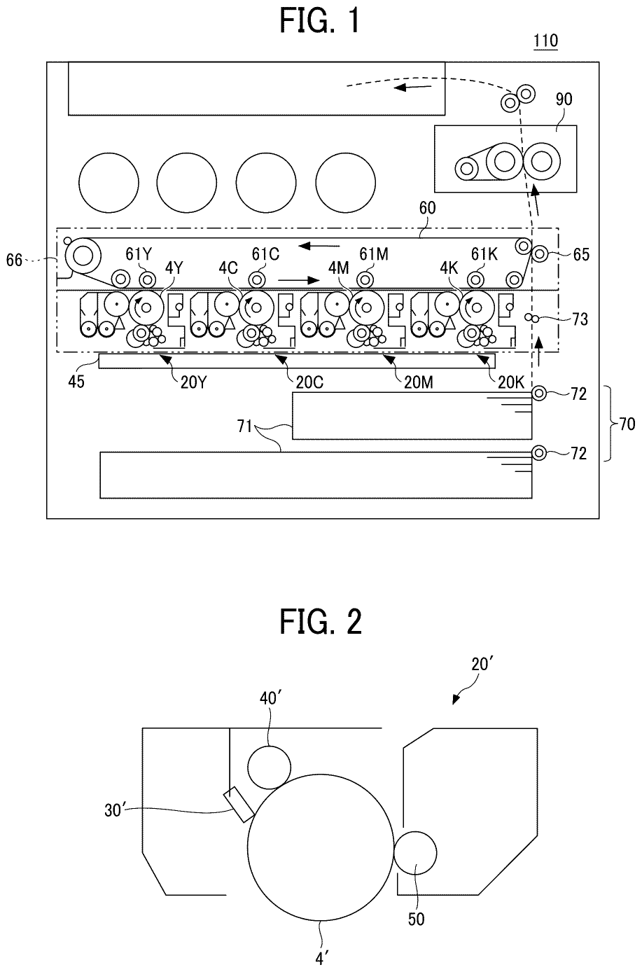

An aspect of the image forming device of the present disclosure is described with reference to FIG. 1. The present disclosure is not limited to these embodiments. In the drawings, identical components may be denoted by the same reference numerals (or symbols), and redundant descriptions may be omitted. The number, position, and shape of the components described below are not limited to those of the present embodiment, and may be appropriately modified as desired for implementing the image forming apparatus of the present embodiment.

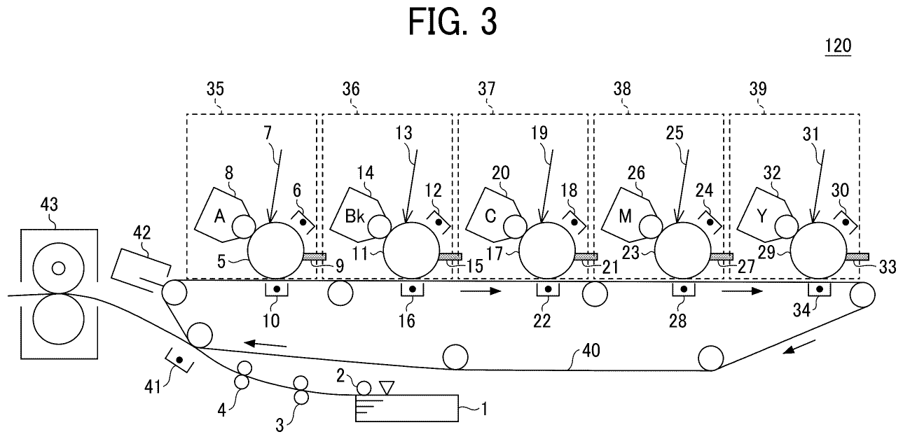

FIG. 1 is a diagram illustrating a schematic diagram of the image forming apparatus according to an embodiment of the present invention. In FIG. 1, the developing device for the toner of the present embodiment is omitted. However, an image forming apparatus 110 includes the developing device for the toner of the present embodiment in the same manner as the developing devices for the toners of the other colors (FIG. 3). The image forming apparatus 110 in FIG. 1 is described assuming that an image forming unit 20A for the toner of the present embodiment, a drum photoconductor 4A as a latent electrostatic image bearer, and a primary transfer roller 61A are present for convenience.

The image forming apparatus illustrated in FIG. 1 is a so-called tandem image forming apparatus, which includes five toner image forming units 20Y, 20C, 20M, 20K, and 20A disposed side by side for yellow, cyan, magenta, black, and white, respectively, and overlaps the color toner images of yellow (Y), cyan (C), magenta (M), black (B), and white (A) formed by the individual toner image forming units to form a full color image. The arrangement order of the toner image forming units of the colors is not particularly limited.

The toner image forming units 20Y, 20C, 20M, 20K, and 20A respectively include drum photoconductors 4Y, 4C, 4M, 4K, and 4A rotationally driven as latent electrostatic image bearers. In addition, an irradiator 45 is disposed to irradiate each of the drum photoconductors 4Y, 4C, 4M, 4K, and 4A with laser beams or LED light based on the image information of each color to form latent images.

An intermediate transfer belt 60 whose surface is movable is disposed as an intermediate transfer member, facing each of the toner image forming units 20Y, 20C, 20M, 20K, and 20A. Primary transfer rollers 61Y, 61C, 61M, 61K, and 61A for transferring the respective color toner images formed on the drum photoconductors 4Y, 4C, 4M, 4K, and 4A to the intermediate transfer belt 60 are respectively disposed, facing the drum photoconductors 4Y, 4C, 4M, 4K, and 4A via the intermediate transfer belt 60.

The primary transfer rollers 61Y, 61C, 61M, 61K, and 61A sequentially transfer the color toner images formed by the toner image forming units 20Y, 20C, 20M, 20K, and 20A described later onto the intermediate transfer belt 60 to form an overlapped full-color image thereon.

A secondary transfer device 65 that collectively transfers the toner image on the intermediate transfer belt 60 onto a transfer medium is disposed downstream of the primary transfer rollers 61Y, 61C, 61M, 61K, and 61A in the surface moving direction of the intermediate transfer belt 60. Moreover, a belt cleaning device 66 for removing the toner remaining on the surface of the intermediate transfer belt 60 is disposed downstream of the secondary transfer device 65.

A sheet feeding unit 70 including sheet feeding cassettes 71, sheet feeding rollers 72, etc. is disposed at the bottom of the image forming apparatus and feeds the transfer medium toward registration rollers 73. The registration rollers 73 send the transfer medium toward the opposing portion of the intermediate transfer belt 60 and the secondary transfer device 65 in accordance with the timing of the toner image formation. The full color toner image on the intermediate transfer belt 60 is transferred onto the transfer medium by the secondary transfer device 65, fixed by the fixing device 90, and thereafter ejected outside the machine.

Each of the toner image forming units 20Y, 20C, 20M, 20K, and 20A is then described below.

Since the configuration and operation of each of the toner image forming units 20Y, 20C, 20M, 20K, and 20A are substantially the same except that the color of the accommodated toner is different, the suffixes Y, C, M, K, and A are omitted in the following descriptions of the configuration and operation of the toner image forming unit 20′.

FIG. 2 is a diagram illustrating a part of a schematic configuration of the image forming apparatus according to a present embodiment of the present disclosure.

Various devices for conducting the electrophotographic processes such as a charger 40′, a developing device 50′, and a cleaner 30′ are disposed around a drum photoconductor 4′ as a latent electrostatic image bearer of the toner image forming units 20′ to form each color toner image on the drum photoconductor 4′ by known operations. Such a toner image forming unit 20′ can be a process cartridge integrated in and detachably attachable to the image forming apparatus 100.

FIG. 3 is a diagram illustrating a part of a schematic configuration of the image forming apparatus according to a present embodiment of the present disclosure. The overlapping description of the image forming apparatus described above is omitted.

An image forming apparatus 120 according to the present embodiment includes a photoconductors (a photoconductor 5, a photoconductor 11, a photoconductor 17, a photoconductor 23, and a photoconductor 29) as latent electrostatic image bearers. Around the photoconductors are disposed chargers (a charger 6, a charger 12, a charger 18, a charger 24, and a charger 30, developing devices (a developing device 8, a developing device 14, a developing device 20, a developing device 26, and a developing device 32), transfer units (a transfer unit 10, a transfer unit 16, a transfer unit 22, a transfer unit 28, and a transfer unit 34) as transfer devices, and cleaners (a cleaner 9, a cleaner 15, a cleaner 21, a cleaner 27, and a cleaner 33). The photoconductors are irradiated with beams of light (beams of light 7, beams of light 13, beams of light 19, beams of light 25, and beams of light 31).

Each color developing unit includes the devices such as the photoconductor, the charger, the developing device, and the cleaner. A developing unit 35 forms an image with the toner of the present disclosure, a developing unit 36 forms an image with a black toner, a developing unit 37 forms an image with a cyan toner, a developing unit 38 forms an image with a magenta toner, and a developing unit 39 forms an image with a yellow toner. Each developing unit transfers the corresponding image to an intermediate transfer belt 40 to form an image.

The image formed on the intermediate transfer belt 40 is transferred onto a transfer medium by a transfer device 41 and fixed by a fixing device 43. Below the developing unit are disposed a feeding cassette 1 and a sheet feeding roller 72, which feeds a transfer medium towards registration rollers 3 and 4. The registration rollers 3 and 4 send out the transfer medium toward the opposing portion of the intermediate transfer belt 40 and the transfer device 41 in accordance with the timing of the toner image formation.

Preferably, the toner image of the present embodiment is formed on the transfer medium.

The transfer medium is preferably a support for release, and may also be a flexible recording medium.

Method of Thermally Transferring and Fixing Toner Image onto Medium Such as Fabric

Next, the method of thermally transferring and fixing the toner image formed by the aforementioned process onto a medium such as fabric using a support for release is described.

The toner image printed on the support for release is repeatedly printed with toner until the toner reaches a particular thickness. The preferred image thickness is between 50 μm and 150 μm, and more preferably between 50 μm and 100 μm. If the image thickness is less than 50 μm, cracks are likely to occur due to image stretching and shrinking. If the image thickness exceeds 150 μm, the hardened print makes them uncomfortable to wear. Additionally, toner offsetting becomes more likely. The image thickness can be measured by taking a magnified cross-sectional photograph of the image using a microscope.

The fabric or other medium is placed over the toner image on the support for release, and a release paper is overlaid, after which heat and pressure are applied. This can be done using a commercially available household iron or a professional heat press machine (e.g., Paiotech Manual Heat Press PHP-MS233). The heat and pressure to be applied are selected to appropriate values based on the thermal properties of the toner, the type of fabric, and the thickness of the fabric. Subsequently, the release paper and the support for release are peeled off, and the toner image is thermally transfer-fixed onto the fabric such as cloth.

Thereafter, optionally release paper is placed again over the toner image and heat and pressure are reapplied to finish and fix the toner image.

Having generally described preferred embodiments of this disclosure, further understanding can be obtained by reference to certain specific examples which are provided herein for the purpose of illustration only and are not intended to be limiting. In the descriptions in the following examples, the numbers represent weight rations in parts, unless otherwise specified.

### EXAMPLES

Next, the present embodiment is described in detail with reference to Examples and Comparative examples but not limited thereto.

### Example 1

### Manufacturing Toner

### Raw Material

Polyurethane resin: ECOFREEN POWDER (manufactured by ECOFREEN Co., Ltd.; Glass Transition Temperature: −29 degrees Celsius; Mw: 47,000; Constituent Components: 1,4-butanediol, adipic acid, diphenylmethane diisocyanate) Content: 52 percent by mass
Polyester resin, RN-306SF (manufactured by Kao Corporation): 18 percent by mass
   Wax dispersant (EXD-001, manufactured by Sanyo Chemical Industries, Ltd.); 2.5 percent by mass
Ester wax, LW-13, available from Sanyo Chemical Industries, Ltd.); 2.5 percent by mass
   Titanium Oxide (white pigment, PF-739, manufactured by ISHIHARA SANGYO KAISHA): 25 percent by mass

The toner's raw materials were first pre-mixed using a Henschel mixer (FM20B, manufactured by Nippon Coke & Engineering Co., Ltd.) The resulting mixture was then melt-kneaded at 90 degrees Celsius using a batch-type kneader (Wonder Kneader WDS7-30, manufactured by Moriyama Mfg. Works, Ltd.). The resulting kneaded material was extruded through a 3 mm diameter die using a feeder loader to form strands, which were then cooled and solidified in a water bath maintained at a temperature of at most 15 degrees Celsius. The solidified strands were cut using a pelletizer to obtain toner pellets with both a diameter and length of 2 mm. These toner pellets constitute the coarsely pulverized product of the toner component melt-kneaded material.

Next, the toner pellets were cooled using liquid nitrogen in a cooling device and then pulverized using a mechanical pulverizer (Linx Mill LX, manufactured by Hosokawa Micron Corporation). The pulverized material discharged from the pulverizer was sieved through a 37 μm mesh. The portion that did not pass through the mesh was returned to the pulverizer, and the fine particles that passed through the 37 μm mesh were collected.

The fine particles were allowed to return to room temperature after passing through the 37 μm mesh, and then classified using an air classifier (EJ-LABO, manufactured by Matsubo Corporation). During classification, the louver opening was appropriately adjusted so that particles with a volume-average particle diameter of at most m accounted for no more than 10 percent by number, thereby obtaining toner base particles (mother toner particles).

Then 1.0 part by mass of Additive 1 (silica, HDK-2000, manufactured by Clariant AG) and 1.0 part by mass of Additive 2 (silica, H05TD, manufactured by Clariant AG) were admixed and agitated with 100 parts of the toner base particles by a HENSCHEL MIXER to prepare Toner of Example 1.

### Manufacturing of Two Component Developing Agent

### Manufacturing of Carrier

| | | |
|---|---|---|
| Silicone resin (Organo straight silicone): | 100 | parts |
| Toluene | 100 | parts |
| γ-(2-aminoethyl) aminopropyl trimethoxy silane: | 5 | parts |
| Carbon Black: | 10 | parts |

The mixture specified above was dispersed by a Homomixer for 20 minutes to prepare a liquid for forming a coating layer.

This liquid was applied to Mn ferrite particles, which have a weight average particle size of 35 μm, as core material, using a fluidized bed coating device. The temperature inside the fluidizing chamber was controlled at 70 degrees Celsius to form a coating layer with an average thickness of 0.20 μm on the surface of the core particles. The coated particles were then dried to obtain a carrier.

The thus-obtained carrier was baked in an electric furnace at 180 degrees Celsius for two hours to obtain Carrier A.

### Manufacturing of Two Component Developing Agent

Toner of Example 1 and Carrier A were uniformly mixed and charged by a TURBULA® mixer (manufactured by Willy A. Bachofen AG) at 48 rpm for five minutes to manufacture Two component Developing Agent of Example 1. The toner-to-carrier mixing ratio was adjusted to obtain the initial toner concentration of 7 percent by mass in the developing agent used in the evaluation machine.

### Example 2

### Raw Material

Polyurethane resin: ECOFREEN POWDER (manufactured by ECOFREEN Co., Ltd.; Glass Transition Temperature: −29 degrees Celsius; Mw: 47,000; Constituent Components: 1,4-butanediol, adipic acid, diphenylmethane diisocyanate) Content: 75 percent by mass
Polyester resin, RN-306SF (manufactured by Kao Corporation): 5 percent by mass
   Wax dispersant (EXD-001, manufactured by Sanyo Chemical Industries, Ltd.); 2.5 percent by mass
Ester wax, LW-13, available from Sanyo Chemical Industries, Ltd.); 2.5 percent by mass
   Titanium oxide (white pigment, PF-739, manufactured by ISHIHARA SANGYO KAISHA): 15 percent by mass Toner and Two-component Developing Agent of Example 2 were prepared in the same manner as in Example 1 except that the raw materials specified above were used instead.

### Example 3

### Raw Material

Polyurethane Resin(Manufactured by DIC Covestro Polymer Co., Ltd.; Glass Transition Temperature: −36 degrees Celsius; Mw: 127,000; Compositional Components: 1,4-Butanediol, adipic acid, diphenylmethane diisocyanate); Content: 55 percent by mass
Polyester resin, RN-306SF (manufactured by Kao Corporation): 5 percent by mass
   Wax dispersant (EXD-001, manufactured by Sanyo Chemical Industries, Ltd.); 2.5 percent by mass
Ester wax, LW-13, available from Sanyo Chemical Industries, Ltd.); 2.5 percent by mass
   Titanium Oxide (white pigment, PF-739, manufactured by ISHIHARA SANGYO KAISHA): 35 percent by mass

Toner and Two-component Developing Agent of Example 3 were prepared in the same manner as in Example 1 except that the raw materials specified above were used instead.

### Example 4

### Raw Material

Polyurethane Resin(Manufactured by DIC Covestro Polymer Co., Ltd.; Glass Transition Temperature: −36 degrees Celsius; Mw: 127,000; Compositional Components: 1,4-Butanediol, adipic acid, diphenylmethane diisocyanate); Content: 51 percent by mass
Polyester resin, RN-306SF (manufactured by Kao Corporation): 4 percent by mass
   Wax dispersant (EXD-001, manufactured by Sanyo Chemical Industries, Ltd.); 2.5 percent by mass
Ester wax, LW-13, available from Sanyo Chemical Industries, Ltd.); 2.5 percent by mass
   Titanium Oxide (white pigment, PF-739, manufactured by ISHIHARA SANGYO KAISHA): 40 percent by mass

Toner and Two-component Developing Agent of Example 4 were prepared in the same manner as in Example 1 except that the raw materials specified above were used instead.

### Comparative Example 1

### Raw Material

Polyurethane resin: ECOFREEN POWDER (manufactured by ECOFREEN Co., Ltd.; Glass Transition Temperature: −29 degrees Celsius; Mw: 47,000; Constituent Components: 1,4-butanediol, adipic acid, diphenylmethane diisocyanate); Content: 35 percent by mass
Polyester resin, RN-306SF (manufactured by Kao Corporation): 5 percent by mass
   Wax dispersant (EXD-001, manufactured by Sanyo Chemical Industries, Ltd.); 2.5 percent by mass
Ester wax, LW-13, available from Sanyo Chemical Industries, Ltd.); 2.5 percent by mass
   Titanium Oxide (white pigment, PF-739, manufactured by ISHIHARA SANGYO KAISHA): 55 percent by mass

Toner and Two-component Developing Agent of Comparative Example 1 were prepared in the same manner as in Example 1 except that the raw materials specified above were used instead.

Regarding Examples 1 to 4 and Comparative Example 1, each property was evaluated in the following manner. The results are shown in Table 1.

### Measurement of True Density of Toner

True density measurements were conducted for each toner using the Accupyc II 1340 instrument. The results are shown in Table 1.

### Measurement of Average Circularity of Toner

The average circularity of the toner was measured using a flow-type particle image analyzer (FPIA®-3000, manufactured by Sysmex Corporation). In a 100-mL glass beaker, 0.1 to 0.5 mL of a surfactant solution (10 percent by mass alkylbenzenesulfonate, Neogen® SC-A, manufactured by Daiichi Kogyo Seiyaku Co., Ltd.) was added, followed by 0.1 to 0.5 g of the toner. The mixture was stirred with a micro spatula, and then 80 mL of deionized water was added to prepare a liquid dispersion.

The liquid dispersion obtained is subjected to ultrasonic dispersion for 3 minutes using an ultrasonic disperser (manufactured by Honda Electronics Co., Ltd.). The measurement sample was then analyzed with an analysis software (FPIA®-3000), and the average circularity of the toner was measured until the particle concentration of the toner reaches 5,000 to 15,000 particles/μL. The results are shown in Table 1.

### Measurement of Volume Average Particle Diameter of Toner

The volume average particle diameter of the toner was measured using a laser diffraction particle size distribution analyzer (SALD-2300, manufactured by Shimadzu Corporation). In a 100 mL glass beaker, 0.5 mL of a surfactant solution (10 percent by mass alkylbenzenesulfonate, Neogen® SC-A, manufactured by Daiichi Kogyo Seiyaku Co., Ltd.) was added, followed by 2 to 4 g of the toner. The mixture was stirred with a micro spatula, and then 80 mL of deionized water was added to prepare a liquid dispersion.

The liquid dispersion obtained was subjected to ultrasonic dispersion for 10 minutes using an ultrasonic disperser (W-113MK-II, manufactured by Honda Electronics Co., Ltd.). The measurement sample was then analyzed using a laser diffraction particle size distribution analyzer to determine the volume average particle diameter. The results are shown in Table 1.

### Method of Measuring Apparent Loose Bulk Density of Toner

A stoppered graduated cylinder having a capacity of 50 cm³ (tolerance: ±0.25 mL, calibrated at 20 degrees Celsius was pre-weighed. Subsequently, 14 g of the toner was added to the cylinder. Next, the cylinder was stoppered and shaken manually 10 times to agitate the toner. The cylinder was then left to stand for 10 minutes, and the toner volume was determined. The apparent loose bulk density was then calculated based on the formula (1) above. The results are shown in Table 1.

### Measurement of Softening Point Ts of Toner

The softening point of toner was measured with a flow tester, CFT-500D, manufactured by Shimadzu Corporation. The toner was pelletized under the minimum pressure at which it could be molded into tablets. The resulting pellets were stored in a thermostatic chamber at 80 degrees Celsius for 30 minutes, and then allowed to cool naturally to room temperature to obtain a toner sample. The softening point Ts of the toner sample was subsequently measured using a flow tester. The flow tester softening point Ts of toner was obtained from the flow curve measured with a flow tester CFT-500, manufactured by Shimadzu Corporation.

The measurement conditions were as follows.
Amount of sample: 1.00±0.05 g
Onset temperature: 40 degrees Celsius
Peak temperature: 200 degrees Celsius
Temperature rising speed: 3.0 degrees Celsius/min
Load for test: 35 kgf
Die opening diameter: 0.5 mm
Die length: 1.0 mm

In cases where no shoulder appears on the piston stroke curve corresponding to Ts during the above flow tester measurement, Ts cannot be automatically detected by the software provided with the flow tester. Accordingly, in such cases, Ts was regarded as being below 40 degrees Celsius. The results are shown in Table 1.

### Observation of Toner Cross-Section (Crushed Product of Melt-Kneaded Toner Components)

The presence or absence of a sea-island structure in each toner was confirmed by observing reflected electron images using a scanning electron microscope (SEM), based on the particle cross-section of a coarsely pulverized product obtained from melt-kneading toner components. The presence of the matrix phase (sea part) and the dispersed phase-separated domains (island domains) can be identified by the color difference between polyester and urethane.

Optionally, to facilitate the identification of the sea part and island domains, the toner was stained with ruthenium tetroxide (available from TAAB Laboratories Equipment Ltd.) to enhance contrast. The cross section of each ruthenium-stained, coarsely pulverized product of the melt-kneaded toner composition mixture was imaged by SEM at approximately the midpoint of the particle diameter under the following conditions, in order to confirm the presence of the sea-island structure. The procedures are as follows.

Each particle of the coarsely pulverized products of melt-kneaded toner composition mixture of each toner was embedded in epoxy resin and observed with an SEM (SU8230, manufactured by Hitachi Ltd.) under the following conditions. During the observation, the non-stained portions are observed as dark, being distinct from the stained portions, i.e., light portions.
Accelerated voltage: 5 kV
Emission current: 10 μA
Probe current: Norm
Condenser lens 1:5.0
WD.: 8.0 mm
Observation mode: SE
Magnification: ×2,000 or ×5,000

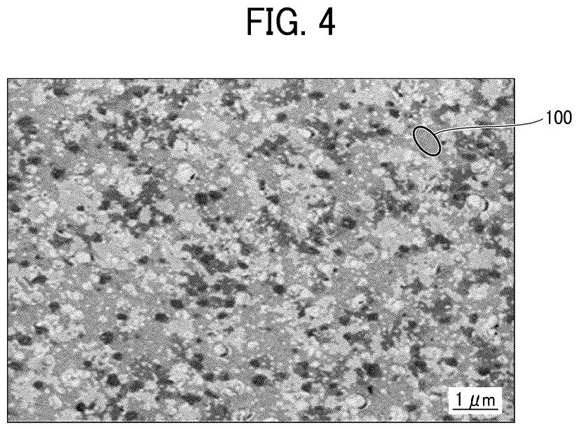

FIG. 4 is a typical cross sectional scanning electronic microscopy (SEM) image of a coarsely pulverized product of melt-kneaded toner composition mixture of the toner of Example 1. In FIG. 4, a phase-separated domain 100 represents the entire area corresponding to a phase-separated domain, commonly referred to as the island part. A sea-island structure was observed in the cross sections of the coarsely pulverized products of the melt-kneaded toner composition mixtures of Toners from Examples 1 to 4, whereas the Toner from Comparative Example 1 did not exhibit a sea-island structure in its cross section.

### Evaluation on Screw Lock Resistance

Screw lock resistance testing was conducted as follows using the toners and two-component developing agents of Examples 1 to 4 and Comparative Example 1, and the screw lock resistance was evaluated based on the criteria described below. (1) The toner was placed into the Y-station toner bottle of RICOH IMC2500 (manufactured by Ricoh Co., Ltd.), and a two-component developing agent using the same toner was set into the Y-station developing unit of RICOH IMC2500. The development and transfer conditions were adjusted using the process controller so that the toner adhesion amount would be 0.45 mg/cm², and 500 sheets of full solid toner images were output on Ricoh My Paper A3 PPC. Among the evaluation results below, ratings A and B were determined to be acceptable as toners of the present embodiment. The results are shown in Table 1.

### Evaluation Criteria

A: No defective images were observed, and no defects were found in the screw inside the sub-hopper.

B: Image density gradually decreased, and small lumps formed around the screw section inside the sub-hopper. Due to insufficient supply speed, printing had to be intermittently stopped for forced toner replenishment.

C: Image density gradually decreased, and many lumps formed around the screw section inside the sub-hopper. Eventually, the screw became clogged with toner, resulting in termination of the test.

### Evaluation on Image Robustness

Using the two-component developing agents of Examples 1 to 4 and Comparative Example 1, toner images were heat-transferred onto fabric as described below, and the image robustness of each fixed image was evaluated.

(1) Each two-component developing agent was set in the fifth station of the RICOH Pro C7200S (manufactured by Ricoh Co., Ltd.), and the development and transfer conditions were adjusted using the process controller so that the toner adhesion amount would be 1.0 mg/cm². A solid toner image was output onto the image layer formation area of a release paper (product name: WoW Light 8.0, manufactured by Piotec Co., Ltd.) used as a support for release, which had a silicone-based surface layer (silicone surface layer) formed on its surface.
(2) The toner image transferred onto the release paper was then fixed to prepare an image transfer sheet. The cross section of the toner image on the release paper was magnified and photographed using a microscope, and the image thickness was measured. The results are shown in Table 1.
(3) A 100% polyester fabric was placed over the toner image on the release paper, and heat transfer was performed by applying a 160 degrees Celsius iron with a pressure of 600 g/cm² for 10 seconds to produce a fixed image for evaluation.

After repeating washing and drying 10 times, the fixed image was manually stretched by approximately 1 cm to visually check whether any breakage occurred in the image. Based on the criteria below, the image robustness was evaluated. Among the evaluation results below, ratings A to C were determined to be acceptable as toners of the present embodiment. The results are shown in Table 1.

### Evaluation Criteria

A: No breakage occurred in the fixed image
B: Breakage occurred in 1 to 4 locations of the fixed image
C: Breakage occurred in 5 locations of the fixed image

TABLE 1

| | | Example | Example | Example | Example | Comparative |
|---|---|---|---|---|---|---|
| | | 1 | 2 | 3 | 4 | Example 1 |
| Toner | Content of | 52 | 75 | 55 | 51 | 35 |
| | polyurethane | | | | | |
| | resin | | | | | |
| | (percent by | | | | | |
| | mass) | | | | | |
| | True density | 1.48 | 1.35 | 1.63 | 1.72 | 1.93 |
| | (g/cm³) | | | | | |
| | Average | 0.92 | 0.82 | 0.88 | 0.90 | 0.95 |
| | circularity | | | | | |
| | Volume | 12 | 25 | 20 | 26 | 9 |
| | average | | | | | |
| | particle | | | | | |
| | diameter | | | | | |
| | (μm) | | | | | |
| | Apparent | 0.53 | 0.41 | 0.48 | 0.43 | 0.56 |
| | loose bulk | | | | | |
| | density | | | | | |
| | (g/cm³) | | | | | |
| | Softening | Less | Less | Less | Less | Less |
| | temperature | than 40 | than 40 | than 40 | than 40 | than 40 |
| | (degrees | | | | | |
| | Celsius) | | | | | |
| Image | Presence of | Yes | Yes | Yes | Yes | Yes |
| transfer | absence of | | | | | |
| sheet | silicone | | | | | |
| | surface layer | | | | | |
| | at support for | | | | | |
| | release | | | | | |
| | Image | 78 | 76 | 80 | 80 | 76 |
| | thickness | | | | | |
| | (μm) | | | | | |
| Evaluation | Image | B | A | B | B | C |
| | robustness | | | | | |
| | Screw lock | B | A | A | B | C |
| | resistance | | | | | |

The toners of Examples 1 to 4 received ratings of A or B for both image robustness and screw lock resistance, indicating their suitability for use in the present embodiment. In contrast, the toner of Comparative Example 1 received a rating of C in both categories, suggesting it is unsuitable for implementation in the present embodiment.

The toners of Examples 1 to 4 received ratings of A or B for both image robustness and screw lock resistance, indicating their suitability for use in the present embodiment. In contrast, the toner of Comparative Example 1 received a rating of C in both categories, suggesting it is unsuitable for implementation in the present embodiment.

### Aspects of Present Disclosure

The present disclosure includes the following aspects.

### Aspect 1

A toner contains a binder resin containing a polyurethane resin, wherein the toner has a true density of 1.30 to 1.80 g/cm3, an average circularity of less than 0.93, a volume average particle diameter of 10 to 30 μm, and an apparent loose bulk density of less than 0.55, wherein the polyurethane resin accounts for at least 51 percent by mass of the toner.

### Aspect 2

The toner according to Aspect 1 mentioned above, wherein the average circularity is less than 0.90 and the apparent loose bulk density is less than 0.50.

### Aspect 3

The toner according to Aspect 1 or 2 mentioned above, wherein the toner has a softening point of lower than 40 degrees Celsius.

### Aspect 4

The toner according to any one of Aspects 1 to 3 mentioned above, wherein the polyurethane resin has at least a structural unit derived from an aliphatic diol and has a glass transition temperature of at most 0 degrees Celsius.

### Aspect 5

The toner according to any one of Aspects 1 to 4 mentioned above, wherein the polyurethane resin has at least structural units derived from 1,4-butane diol, adipic acid, and diphenylmethane diisocyanate and has a weight average molecular weight of 40,000 to 130,000.

### Aspect 6

A toner set contains a color toner containing a binder resin and a colorant; and the toner of any one of Aspects 1 to 5 mentioned above.

### Aspect 7

An image transfer sheet contains a support for release and an image formed with the toner of any one of Aspects 1 to 4 mentioned above on the support for release.

### Aspect 8

The image transfer sheet according to Aspect 7 mentioned above, wherein the support for release has a layer at a surface thereof, the layer containing a silicone component or a fluorine component.

### Aspect 9

A toner accommodating unit includes a container and the toner of any one of Aspects 1 to 5 mentioned above accommodated in the container.

### Aspect 10

An image forming apparatus includes a latent electrostatic image bearer, a latent electrostatic image forming device to form a latent electrostatic image on the latent electrostatic image bearer, a developing device to develop the latent electrostatic image formed on the latent electrostatic image bearer with a developing agent containing the toner of any one of Aspects 1 to 5 mentioned above to obtain a toner image, a transfer device to transfer the toner image onto a support for release or a flexible printing medium with a surface roughness of at least 1 μm, and a fixing device to fix the toner image transferred to the support or the flexible printing medium.

### Aspect 11

An image forming method includes forming a latent electrostatic image on a latent electrostatic image bearer, developing the latent electrostatic image formed on the latent electrostatic image bearer with a developing agent containing the toner of any one of Aspects 1 to 5 mentioned above to obtain a toner image, transferring the toner image on the latent electrostatic image bearer overlying a support for release or a flexible printing medium with a surface roughness of at least 1 μm, and fixing the toner image transferred onto the support or the flexible printing medium.

### Aspect 12

The image forming method according to Aspect 11 mentioned above, further includes forming the toner image closest on the support for release or the flexible printing medium.

### Aspect 13

The image forming method according to Aspect 11 or 12 mentioned above, wherein the flexible printing medium is fabric made from fibers.

### Aspect 14

The image forming method according to any one of Aspects 11 to 13 mentioned above, wherein the toner image has a thickness of 50 to 150 μm.

Some embodiments of the present disclosure are described above, these embodiments are described for illustration purpose only, and the present disclosure is not limited thereto.

These embodiments can be enforced in other forms and various combinations, omissions, replacement, and modifications can be made within the scope of the effect of the present disclosure.

Such embodiments and variations are within the scope and effect of the present disclosure and are included in the disclosure described in the scope of the claims and their equivalents.

1. A toner comprising:
a binder resin comprising a polyurethane resin,
wherein the toner has a true density of 1.30 to 1.80 g/cm³, an average circularity of less than 0.93, a volume average particle diameter of 10 to 30 μm, and an apparent loose bulk density of less than 0.55,
wherein the polyurethane resin accounts for at least 51 percent by mass of the toner.

2. The toner according to claim 1,
wherein the average circularity is less than 0.90 and the apparent loose bulk density is less than 0.50.

3. The toner according to claim 2,
wherein the toner has a softening point of lower than 40 degrees Celsius.

4. The toner according to claim 3,
wherein the polyurethane resin has a structural unit derived from an aliphatic diol and has a glass transition temperature of at most 0 degrees Celsius.

5. The toner according to claim 4,
wherein the polyurethane resin has structural units derived from 1,4-butane diol, adipic acid, and diphenylmethane diisocyanate and has a weight average molecular weight of 40,000 to 130,000.

6. A toner set comprising:
a color toner comprising a binder resin and a colorant; and
the toner of claim 1.

7. An image transfer sheet comprising:
a support for release; and
an image formed with the toner of claim 1 on the support for release.

8. The image transfer sheet according to claim 7,
wherein the support for release has a layer at a surface thereof, the layer containing a silicone component or a fluorine component.

9. A toner accommodating unit comprising:
a container; and
the toner of claim 1 accommodated in the container.

10. An image forming apparatus comprising:
a latent electrostatic image bearer;
a latent electrostatic image forming device to form a latent electrostatic image on the latent electrostatic image bearer;
a developing device to develop the latent electrostatic image formed on the latent electrostatic image bearer with a developing agent containing the toner of claim 1 to obtain a toner image;
a transfer device to transfer the toner image formed on the latent electrostatic image bearer to a support for release or a flexible printing medium having a surface roughness of at least 1 μm; and
a fixing device to fix the toner image transferred onto the support for release or the flexible printing medium.

11. An image forming method comprising:
forming a latent electrostatic image on a latent electrostatic image bearer;
developing the latent electrostatic image formed on the latent electrostatic image bearer with a developing agent containing the toner of claim 1 to obtain a toner image;
transferring the toner image formed on the latent electrostatic image bearer to a support for release or a flexible printing medium having a surface roughness of at least 1 μm; and
fixing the toner image transferred onto the support or the flexible printing medium.

12. The image forming method according to claim 11,
further comprising forming the toner image closest on the support or the flexible printing medium.

13. The image forming method according to claim 12,
wherein the flexible printing medium is fabric made from fibers.

14. The image forming method according to claim 13,
wherein the toner image has a thickness of 50 to 150 μm.
